(19) United States
(12) Patent Application Publication
(10) Pub. No.: US 2026/0119209 A1
(43) Pub. Date: Apr. 30, 2026

(54) GENERATIVE AND MALLEABLE USER INTERFACES WITH EVOLVING TASK-DRIVEN DATA SCHEMA

(71) Applicant: The Regents of the University of California, Oakland, CA (US)

(72) Inventors: Haijun Xia, San Diego, CA (US); Yining Cao, La Jolla, CA (US); Peiling Jiang, San Diego, CA (US)

(21) Appl. No.: 19/376,694

(22) Filed: Oct. 31, 2025

Related U.S. Application Data
(60) Provisional application No. 63/714,512, filed on Oct. 31, 2024.

(51) Int. Cl. G06F 9/451

(52) U.S. Cl. CPC G06F 9/451

(57) ABSTRACT

Methods and systems for generating a graphical user interface for a user task are described. An example method for generating a graphical user interface for a user task includes receiving, from a user, a natural language prompt describing the user task, and generating, based on an output of a large language model configured to process the natural language prompt, a task-driven data model comprising a task object that includes multiple entity objects and multiple dependencies between objects. The method then includes determining, for each attribute of at least one of the multiple entity objects, a first label indicative of a user interface component for the entity object, rendering the graphical user interface that includes a panel comprising the user interface component, and providing the graphical user interface to a display device. An example system includes one or more processors configured to implement the above-described method.

### CROSS-REFERENCE TO RELATED APPLICATION

This patent document claims priority to and benefits of U.S. Provisional Patent Application No. 63/714,512 filed Oct. 31, 2024. The entire content of the before-mentioned patent application is incorporated by reference as part of the disclosure of this patent document.

### TECHNICAL FIELD

This patent document is generally related to user interfaces, and more particularly, to generative and malleable user interfaces.

### BACKGROUND

User interfaces (UIs) for tasks should be intuitive, user-friendly, and efficient. They must facilitate easy navigation, clear instructions, and quick access to essential functions. Effective UIs enhance productivity by minimizing user effort and reducing errors, ensuring a seamless interaction between the user and the system. Key elements include responsive design, which adapts to various devices and screen sizes, and accessibility features to accommodate users with disabilities. Additionally, incorporating feedback mechanisms, such as progress indicators and error messages, helps users stay informed and correct mistakes promptly. Overall, a well-designed UI significantly improves the user experience and task completion efficiency.

### SUMMARY

Unlike static and rigid user interfaces, a generative and malleable user interface (UI) offers the potential to respond to diverse users' goals and tasks. However, current approaches primarily rely on generating code, making it difficult for end-users to iteratively tailor the generated interface to their evolving needs. The described embodiments employ task-driven data models—representing the essential information entities, relationships, and data within information tasks—as the foundation for UI generation. Artificial intelligence (AI), and large language models (LLMs) in particular, are leveraged to interpret users' prompts and generate the data models that describe users' intended tasks, and by mapping the data models with UI specifications, generative user interfaces can be created. End-users can easily modify and extend the interfaces via natural language and direct manipulation, with these interactions translated into changes in the underlying model. A technical evaluation of the disclosed approach and user evaluation of the developed system demonstrate the feasibility and effectiveness of the proposed generative and malleable UIs.

Embodiments of the disclosed technology relate to generating a graphical user interface (GUI) for a user task. In some examples, the described embodiments employ data schemas, which represent the essential entities and dependencies associated with the user task, to generate the GUI. The disclosed technology enables users to easily inspect, modify, and extend interfaces via natural language and direct manipulation.

In an example aspect, a method for generating a graphical user interface for a user task includes receiving, from a user, a natural language prompt describing the user task, and generating, based on an output of a large language model (LLM) configured to process the natural language prompt, a task-driven data model comprising (a) a task object that includes a plurality of entity objects and (b) a plurality of dependencies between objects. In this example method, the task object is representative of the user task and each of the plurality of entity objects is representative of a goal or a sub-task of the user task, an entity object is associated with an attribute that identifies the entity object as comprising a singular data value, an array of singular data values, a pointer to the entity object, an array of pointers, or a key-value dictionary pair, and a dependency comprises a source object, a target object, a mechanism that either validates a constraint between the source object and the target object or updates the target object based on a change in the source object, and a relationship between the source object and the target object. The method further includes determining, for each attribute of at least one of the plurality of entity objects, a plurality of labels that includes a first label indicative of a user interface component for the entity object, rendering, based on the plurality of labels for the task object and at least one of the plurality of entity objects, the graphical user interface that includes a panel comprising the user interface component, and providing, to a display device, the graphical user interface.

In another example aspect, a system for generating a graphical user interface for a user task includes one or more processors and a display device. The one or more processors is configured to receive, from a user, a natural language prompt describing the user task, and generate, based on the natural language prompt, a task-driven data model comprising (a) a task object that includes a plurality of entity objects and (b) a plurality of dependencies between objects. In this system, the task object is representative of the user task and each of the plurality of entity objects is representative of a goal or a sub-task of the user task, an entity object is associated with an attribute that identifies the entity object as comprising a data structure, and a dependency comprises a source object, a target object, a mechanism that either validates a constraint between the source object and the target object or updates the target object based on a change in the source object, and a relationship between the source object and the target object. The one or more processors is further configured to determine, for the task object and at least one of the plurality of entity objects, a plurality of labels that includes a first label indicative of a user interface component for the entity object, render, based on the plurality of labels for the task object, a home panel, and render, based on the plurality of labels for at least one of the plurality of entity objects, at least one entity panel comprising the user interface component. The display device is configured to visually present, to the user, the graphical user interface comprising the home panel and the at least one entity panel.

In yet another example, aspect, a system for generating a graphical user interface for a user task includes one or more processors configured to receive, from a user, a natural language prompt describing the user task, and generate, based on an output of a large language model (LLM) configured to process the natural language prompt, a task-driven data model comprising (a) a task object that includes a plurality of entity objects and (b) a plurality of dependencies between objects. In this system, the task object is representative of the user task and each of the plurality of entity objects is representative of a goal or a sub-task of the user task, an entity object is associated with an attribute that identifies the entity object as comprising a data structure, and a dependency comprises a source object, a target object, a mechanism that either validates a constraint between the source object and the target object or updates the target object based on a change in the source object, and a relationship between the source object and the target object. The one or more processors is further configured to determine, for each attribute of at least one of the plurality of entity objects, a plurality of labels that includes a first label indicative of a user interface component for the entity object, render, based on the plurality of labels for the task object and at least one of the plurality of entity objects, the graphical user interface that includes a panel comprising the user interface component, and provide, to a display device, the graphical user interface.

In yet another example aspect, an apparatus comprising a memory and a processor that implements the above-described methods is disclosed.

In yet another example aspect, the above-described methods may be embodied as processor-executable code and may be stored on a non-transitory computer-readable program medium.

The above and other aspects and features of the disclosed technology are described in greater detail in the drawings, the description and the claims.

### BRIEF DESCRIPTION OF THE DRAWINGS

FIGS. 1A-1C illustrate an example of rendering generative and malleable user interfaces from an initial user prompt specifying a user task.

FIG. 2 illustrates an example pipeline for rendering generative and malleable UIs.

FIGS. 3A and 3B illustrate an example format of an object-relational schema and the annotation of attributes within the schema.

FIGS. 4A and 4B illustrate an example of the different views in Jelly.

FIGS. 5A and 5B illustrate an example of switching between different representations of data in an entity panel in Jelly.

FIG. 6 illustrates an example of generating structured data with Jelly.

FIGS. 7A-7C illustrate results of an example user evaluation of Jelly.

FIG. 8 illustrates the results of an example evaluation questionnaire.

FIG. 9 is a flowchart illustrating an example method for generating a graphical user interface for a user task.

FIG. 10 is a block diagram illustrating an example system configured to implement one or more embodiments of the disclosed technology.

### DETAILED DESCRIPTION

Methods and systems directed to generative and malleable user interfaces with task-driven schema are described. The disclosed embodiments employ generative artificial intelligence (GAI), and large language models (LLMs) in particular, to interpret intended tasks from users' prompts and then generate task-driven data schemas that model the essential entities, dependencies, and structures of the user task. The data schemas are used to manage task data and generate UI specifications, which are used to render the graphical user interface (GUI) that the user engages with to perform the task.

Section headings are used in the present document to improve readability of the description and do not in any way limit the discussion or the embodiments (and/or implementations) to the respective sections only.

### 1 Introduction

The vision of personalized and intelligent user interfaces, as portrayed in Apple's 1987 Knowledge Navigator, seems more attainable than ever given the recent advances in AI. We envision the interfaces to be capable of responding to users' diverse requests, and continuously adapting to users' evolving needs by presenting relevant information with effective representations and interactions. A critical challenge in realizing this vision is devising an interface paradigm and technical approach for creating such generative and malleable user interfaces.

Consider the task of hosting a dinner party. One needs to fix the schedule, invite guests, plan the dishes, compare wine options, finalize a shopping list, and determine the optimal shopping route. Under the dominant application-centric interface paradigm, end-users need to cobble together a large number of applications, using a fraction of the functionality of each to accomplish their goals. This fragmented, inefficient workflow is a common experience in our everyday informational tasks. While one could imagine dedicated applications developed for different tasks, it is impractical given the diversity of user needs. In this case, a dedicated “dinner party” application may not exist, and if it did, it would likely become bloated with features while still failing to fully accommodate individual preferences and evolving requirements.

The programming capability of generative models offers one approach to achieve generative and malleable UIs: generating the codebase of a custom application from user prompts, which could be compiled and executed to support users' tasks. However, the code-generation approach makes it challenging for end-users to modify and extend the interfaces when AI's generation inevitably fails to fully align with users' needs or when those needs naturally shift throughout the task. Each new prompt-based revision may result in a discontinuous transition between generated codebases, making it difficult to maintain consistency across iterations; it is also unclear how the data should be transformed when the user's tasks require changing the underlying information structure. The opaque relationship between user prompts and the resulting code further complicates interpretability and control, limiting end-users' ability to steer the generation process effectively.

Embodiments of the disclosed technology provide higher-level generative structures that can guide both UI generation and data transformations while improving end-user control. Such structures to generate interfaces, as will be discussed in this patent document, are both malleable and interpretable.

The described approach adopts the canonical perspective that user interfaces are graphical representations of underlying data models that describe the intended tasks, rooted in the Model-View-Controller (MVC) framework for GUI-based applications and model-based UI development. In this view, traditional applications employ fixed models for predefined tasks, and therefore, the onus is on the users to piece together the separate application models to match their workflows. On the contrary, generative and malleable UIs should dynamically evolve to reflect users' tasks and intentions. To achieve this, we propose leveraging Large Language Models (LLMs) to interpret users' prompts and generate a task-driven data model—a structured representation of the essential entities, relationships, and data properties relevant to the intended task. This model serves as the foundation for generating UI specifications that define the components and composition of the interface. The model will evolve continuously in response to users' changing needs. As such, the dynamically generated and evolving task-driven data models can drive the transformation of the interface and the underlying data, achieving generative and malleable UIs.

The feasibility of this approach is demonstrated by exploring both the technical pipeline and interaction techniques of the generative and malleable UIs with a prototype system, Jelly. The pipeline begins by analyzing user prompts and generating a model that consists of an object-relational schema and a dependency graph. This model then guides the generation of the UIs by representing aspects of the model with predefined UI patterns and rules that reflect common UI design practices. Within Jelly, users can interact with the generated interfaces using natural language and direct manipulation, with these interactions translated to changes in the underlying model. Users can also directly inspect the model to understand the underlying structure of the interface and flexibly customize it to suit their needs.

The efficacy of the LLM-generated data model is analyzed with a technical evaluation. Results show that state-of-the-art LLMs can reliably generate relevant entities and dependencies that can meet the information and interaction needs expressed in users' natural language prompts. The described generative and malleable UIs are the first of their kind to support relatively open-ended information tasks. To assess their effectiveness, a user study was conducted where participants engaged with the system to complete several open-ended information tasks and reflected on how their experiences compared to those with existing GUI applications and AI-powered chat interfaces. The findings show that generative and malleable UIs enabled users to develop highly personalized and dynamic information spaces by flexibly curating diverse information and customizing how information is presented.

The described embodiments provide, amongst other features and benefits, the following advantageous aspects:
A technical approach for generative and malleable UIs based on the generative task-driven data models that evolve with users' tasks.
Jelly, a prototype system that implements the proposed approach, enabling users to flexibly generate and customize user interfaces via natural language and direct manipulation.
Technical and user evaluations demonstrating the feasibility and efficacy of the described approach for rendering generative and malleable user interfaces.

### 2 Example Embodiment for Generative and Malleable UIs

The described embodiments provide dynamic, personalized, and adaptive interfaces that cater to individuals' unique and evolving needs across various domains, scopes, and levels of complexity. Such interfaces are particularly well-suited for information tasks that require integrating data from multiple domains, presenting information in highly personalized ways, and supporting open-ended or exploratory workflows where users' goals and information needs continuously evolve. These types of tasks include but are not limited to planning tasks (e.g., travel and party planning), exploring and learning about a new domain (e.g., red wine, cheese), or multi-factor decision-making tasks (e.g., holiday gift shopping, choosing colleges to attend).

For generative and malleable UIs to effectively support users' information tasks with our model-based approach, the following key aspects need to be addressed: (1) Task Representation. The model needs to employ an effective representation to describe users' information tasks; (2) UI Generation. The model needs to be translated into rich and effective interface representations; (3) Model Evolution. The model needs to dynamically adapt to users' evolving tasks and various customization needs. (4) Data Integration. The model needs to be populated with accurate and relevant data. (5) Context Awareness. The interface should incorporate users' context to provide personalized information and UI configurations.

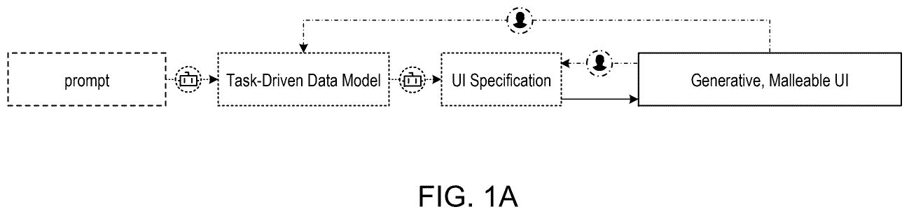

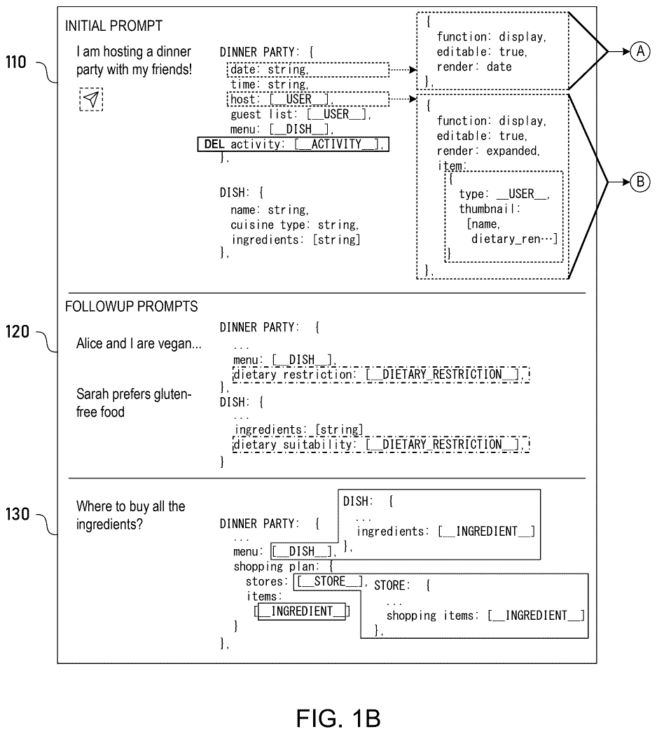

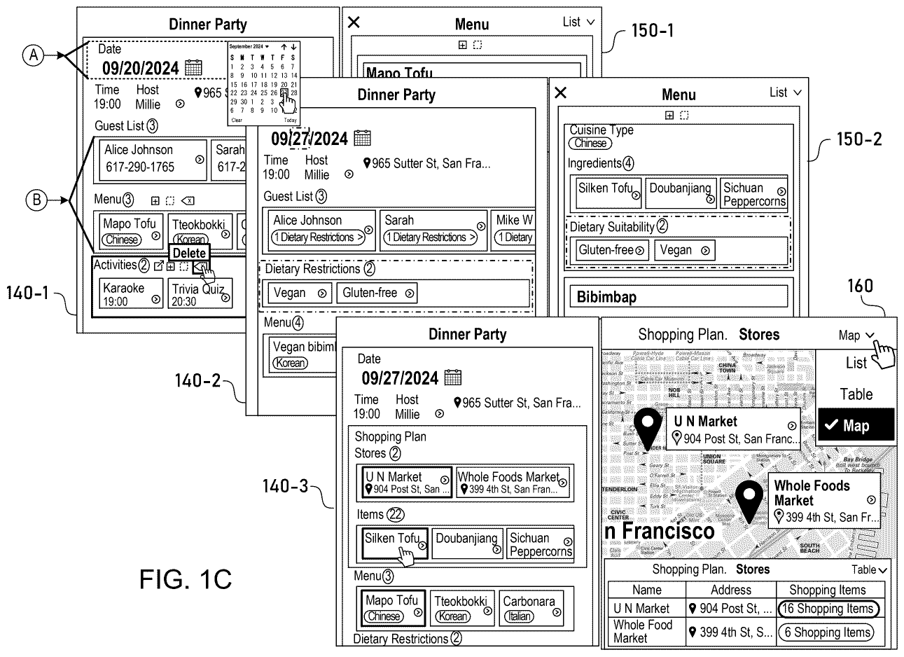

In this patent document, the first three aspects are described in the context of various examples and embodiments. Certain aspects of the disclosed technical pipeline and prototype system (Jelly) are explained using an example scenario. As discussed above, the described embodiments use an LLM to process a prompt and generate a task-driven data model, which is annotated to generate a UI specification that is used to render the generative and malleable UI. This process is shown in FIG. 1A, and FIGS. 1B and 1C illustrate aspects of this process through the example scenario. In the following scenario, it is assumed that Jelly has access to the user's personal information.

Millie is planning to host a dinner party with her friends. Typically, she would have to use the browser to search dishes online, find their recipes, use a note-taking application to record the ingredients and make a shopping plan, use a calendar and several communication applications to coordinate the schedule with her friends, and more.

Instead of juggling all these applications, she opens Jelly and types, “I am hosting a dinner party” (110). Jelly responds with a few follow-up questions with generated GUIs, such as “who to invite” with a list of selectable contact cards; and “when the party is” by presenting a calendar populated with her schedule. After a brief conversation, Jelly generates a home panel for the “Dinner Party Plan” task (140-1), including the time, location, guest list, menu, and activities. Seeing this, Millie realizes that she has forgotten to invite a few people. With Jelly, she can pull up her contact list by clicking on the “all” button beside the guest list. The panel of all her contacts is displayed side-by-side. Contacts already added to the guest list are highlighted in both the guest list and the contact list. Millie then adds the missing guests by tapping on their contact cards.

Millie reviews the recommended dishes in the menu (150-1), deletes the ones she dislikes, and clicks the “add” button next to the menu list to explore more options suggested by Jelly (150-2). While doing so, she realizes that she needs to consider dietary restrictions. She informs Jelly, “Alice and I are both vegan” (120). To fulfill this request, Jelly adds a “dietary restrictions” attribute for all guests and automatically records Alice's and Millie's preferences. Meanwhile, a “dietary suitability” attribute has been added for each dish, flagging dishes violating the dietary restrictions. Millie then replaces them with suggestions made by Jelly. To ensure awareness of the restrictions when planning the activity, Jelly also adds a new section to the home panel summarizing the dietary restrictions of all guests (140-2).

When the menu is finalized, Millie then types “I need to get the ingredients” (130). Recognizing the task shift, Jelly generates a Shopping List panel, organizing the ingredients as shopping items with attributes assisting the ingredient purchasing process: The “total quantity” aggregates the amount needed for all the dishes; the “store” dropdown menu lists all the local stores where the ingredients are available (140-3); and the “bought” checkbox tracks the shopping progress. Jelly presents the stores in a map view for her to plan the shopping trip (160). Clicking on each store on the map shows her all the items that she needs to buy at the store. After reviewing the list, she clicks the “start” button at the bottom of the map, hops in her car, and heads out to shop.

### 3 Overview of Interactive User Interfaces

The described approach adopt the canonical perspective that user interfaces employ interactive graphical representations to encode the underlying data model, similar to the Model-View-Controller (MVC) software design framework for GUI-based applications, and the model-based UI development paradigm. Taking this perspective, traditional GUI applications employ fixed data models and fixed encodings (i.e., program) to create fixed interfaces, resulting in rigid applications designed for specific tasks with specific features. Extensive research has explored various approaches towards the creation of adaptive, dynamic, malleable, and generative UIs. Some of the key approaches are discussed below.

### 3.1 Model-Based User Interfaces

Model-Based User Interfaces (MBUI) development arose as a paradigm that aims to significantly reduce the effort in developing UIs while ensuring quality, initiated by early works on User Interface Management System (UIMS) that proposed decoupling application functionality from the UI. MBUI provides a systematic approach to software design by leveraging abstract models, including task models to structure task workflows, domain models to represent data relationships, and abstract-to-concrete mappings to render the UI components. Utilizing these models, developers can specify interfaces declaratively at a higher level of abstraction. For example, rather than concretely specifying the UI components, such as a set of radio buttons or a dropdown list, MBUI tools allow developers to define their needs declaratively, such as “a widget for selecting a single item from a set,” so the system can decide the most appropriate widget to display based on the specific user scenario, for example, screen sizes of the devices.

Prior works have explored supporting different subprocesses and UI scopes for MBUI. For example, UIDE focuses on dialog box generation by assigning data types to widgets and laying them out on a canvas, while MIKE generates menus and dialog boxes directly from function signatures. MASTERMIND and ITS expand on these approaches by supporting a broader range of interface specifications. Automating the mapping from high-level models to UI specifications has also been a significant focus in prior research. For instance, TRIDENT balances automation with manual refinement, allowing developers to specify presentation and navigation strategies. Despite these advancements, one persistent challenge in MBUI is translating the abstract models into concrete UI components. Systems like HUMANOID and BOSS use reusable templates to address this issue. TIMM further generalizes these solutions into a computational framework that explicitly represents and manages the mappings between abstract and concrete elements.

The disclosed approach takes a similar perspective of separating interface presentation from the underlying system logic that is governed by task-driven data models, and explores automating the process of encoding and mapping between these layers. The primary focus of MBUI, however, has been on assisting developers in creating UIs rather than enabling end-users to modify their interfaces dynamically. Therefore, the models that the MBUI approach produces are predefined and static. Our work, on the other hand, aims to continuously update the underlying model, which drives the transformation of user interfaces to meet the end-users' evolving needs.

### 3.2 Specification-Based UI Generation

Different from the traditional MBUI development paradigm, with which software developers determine the underlying task model, UI model, and their mappings to create a single system, the specification-based UI generation can be seen as a scaffolded approach of MBUI such that interfaces can be specified by end-users or automatically generated. This is typically achieved by constraining one or more aspects within the MBUI approach. For example, Bespoke relies on the specification of command-line applications, and by predefining the mappings between UI widgets to different types of command-line parameters, it enables end-users to create GUIs for command-line applications through demonstration. Similarly, DynaVis leverages the Vega-Lite specification to generate visualization editing interfaces. By mapping UI widgets to visualization parameters, it composes appropriate UI components based on parameters inferred from users' natural language queries. To ensure the quality and consistency of UIs for controlling home appliances, some systems employed a specification language and parameterized templates that encode design conventions, enabling the automatic generation of structured and coherent interfaces.

A unique strength of high-level specification is that it enables developers and end-users to focus on composing high-level domain-specific primitives, delegating low-level execution to the underlying architecture and runtime. By choosing an appropriate level of abstraction and enabling one-to-one mappings between specification and user interface components, end-users can often directly manipulate the specification itself to adjust the generated outcome. Additional interface layers, such as graphical or natural language interfaces, can also be utilized on top of the specification if fully instantiating the specification is tedious.

In this approach, domain experts define the specifications, shaping the UI generation space within a structured yet adaptable framework. While high-level specifications impose constraints compared to low-level programmatic approaches, they improve accessibility by making the entire UI generation space more interpretable and modifiable by end-users. Moreover, these constraints help maintain design consistency and quality across generated interfaces. Building upon this approach, the disclosed embodiments provide a set of UI specifications to translate the data model into interface representations.

### 3.3 End-User Programming/Development

Prior research has explored creating interactive systems that are customizable by end-users, allowing them to tailor the interface to suit their specific needs. This body of work is primarily situated within the field of end-user programming or development (EUP or EUD), where end-users can employ natural language programming, GUI-based interaction, visual programming, and programming-by-demonstration to extend existing systems.

For example, pioneering systems like OpenDoc, HyperCard, Smalltalk, and recent systems, such as DynamicLand and Embark aimed to develop dynamic and personal media for end-users to create their own dynamic content and UIs. Hypercard allows users to develop interactive multimedia content by linking objects via GUI and scripting advanced behaviors using a built-in programming language. These systems pre-define the underlying data model but expose the encoding mechanism to enable end-user development.

Most existing systems, however, do not expose their data models and encoding mechanisms to the end-users. To circumvent this, research has explored constructing external data models and associated encoding mechanisms to enable EUD. For example, Wildcard leverages the accessible and manipulable Document Object Model (DOM) of webpages to enable end-users to collect data from and inject data back into the DOM structure. By representing webpage data in an external spreadsheet, users can manipulate the spreadsheet to customize web pages. Further leveraging the composability and transclusion of the web, prior work explored enabling end-users to create mashup applications tailored to their specific needs. For example, Fusion and C3 W enable users to create mashups by extracting components from existing webpages and connecting them using transclusion, formula, and glue code. Vegemite allows users to collect data from multiple websites; using scripts that can be generated from users' demonstration, it can perform computation on the collected data and automatically execute web actions such as clicking links and inputting data values to web forms. In cases where DOM-like accessibility is unavailable, Research has explored reverse-engineering to extract useful structure and metadata from UI elements. For example, Prefab explores recognizing UI widgets on any GUI applications, and then modifying their behaviors using input and output redirection. Other systems developed machine learning models to extract metadata from UI screens, which can be used to enhance the screen's accessibility.

While EUP/EUD allows users to extend applications, they lack direct access to the applications' internal data models. While external data models (e.g., spreadsheet, recognized interface structures) can serve as the proxies or connectors with the original applications, these external data model are also pre-defined by developers, leaving end-users with limited customizability.

### 3.4 Context-Based UI Adaptation

Prior work has also explored computationally adapting UIs based on various contextual factors and constraints pertinent to the device, user, or situation in domains such as accessibility, ubiquitous computing, and mixed reality. For example, SUPPLE and SUPPLE++ computationally adjust the size, style, and layout of widgets to adapt the user interfaces based on device constraints (e.g., screen size, input modality) and users' capabilities (e.g., motor and vision). UNIFORM and Huddle automatically generate UIs with primitive widgets for controlling home appliances by considering users' interaction history as well as modeling the similarities and dependencies of appliances. Since mobile and Mixed Reality (MR) interfaces can be invoked in arbitrary situations, research has also explored adapting these interfaces based on various environmental factors. For example, earlier research explored how applications should adapt the amount of information they show and their spatial arrangement in MR.

With this approach, the data models of the interactive systems are often extended with developer-defined constraints, which will take effects with anticipated contextual input, resulting in context-aware dynamic interfaces. However, the scope of the dynamic behaviors is pre-defined by developers. Therefore, the adaptability—both in terms of what and how to adapt—is often less controllable by end-users.

### 3.5 AI-Based Code Generation

Recent developments in AI, especially its ability to generate functional program code from natural language prompts, have sparked a new approach towards generative UI. AI products such as Claude and Vercel can generate and render UI code from natural language prompts. Wu et al. explored fine-tuning LLMs with automated feedback to improve the quality of the generated UI code. However, they found that the state-of-the-art AI models could struggle to reliably produce compilable programs (less than 80% compilation success for a single UI screen).

As AI's code generation capability continues to improve, the complexity and quality of AI-generated applications and UIs are expected to increase. This approach presents both opportunities and challenges. On one hand, AI can generate code from arbitrary user requests, making it a more scalable approach for UI generation. On the other hand, the inherent entry barriers associated with programming languages and tasks as well as the opaque mappings between natural language prompts and generated code create significant challenges for end-users in understanding, controlling and customizing the output. Given AI's inconsistent performance—even in generating single-screen UIs—it remains unclear how AI-based code generation can reliably and continuously adapt interfaces to meet users' dynamic and shifting goals. Additionally, current AI-driven code generation approaches primarily focus on generating code for client-side UIs, leaving open challenges on how the server-side data should be structured and transformed.

As a known issue observed across many domains of AI-generated content, creating and iterating via prompting is inherently challenging. To address this, additional high-level control structures are often required. Therefore, it is important to devise high-level structures to guide the generation process, such as imposing additional conditioning constraints for image generation and leveraging compositional structures to ground video generation. In this work, we take a similar approach by introducing task-driven data models—a high-level control structure that guides UI generation and enables users to more easily inspect and adjust the generated interfaces.

### 4 Example Aspects of the Disclosed Technology

The described embodiments provide, amongst other benefits and advantages, the following aspects:

(1) Developing Effective Task-Driven Data Model to Represent Users' Information Tasks. To support users' information tasks with effective UIs, the underlying foundation—the data model—must be able to effectively represent the information tasks. Unlike some traditional models in MBUI that prescribe the interaction and task sequences, which can lead to rigid workflows, the model is designed to represent the essential entities, relationships, and constraints needed to accomplish the information tasks, allowing users to form their own workflows. Additionally, the model is designed in a way that it can be intuitively interpreted and manipulated.

(2) Translating the Task-Driven Data Model into Effective UIs with UI Specification. With the model as the foundation, the specification-based approach is taken to ensure the consistency and expressiveness of the generated UIs. To effectively map the abstract models to concrete UIs, the specification is grounded based on a set of common design patterns that describe what UI widgets (alternatively, UI design elements or UI components) should be used and how they should facilitate interaction with different types of information. For example, the UI specification prescribes which UI components (e.g., dropdown menus, radio buttons, input fields, etc.) correspond to which schema elements using a set of mapping rules. Generative AI is used for generating the specifications; therefore, the specifications are designed to be effectively leveraged by AI for robust and accurate generation of user interfaces.

(3) Providing Interactions for End-Users to Modify the UIs to Align with Their Evolving Needs. To accommodate various interaction modalities and levels of specificity, end-users are empowered to express their intended tasks and UI modifications through both natural language prompts and direct manipulation. These interactions will be translated into updates to the underlying model. In addition, an “Inspect”-like tool may be provided, similar to browser developer tools, for end-users to directly examine and edit the model for enhanced interpretability and control over both the generation process and resulting interfaces.

### 5 Example Technical Pipeline for Generative and Malleable UIs

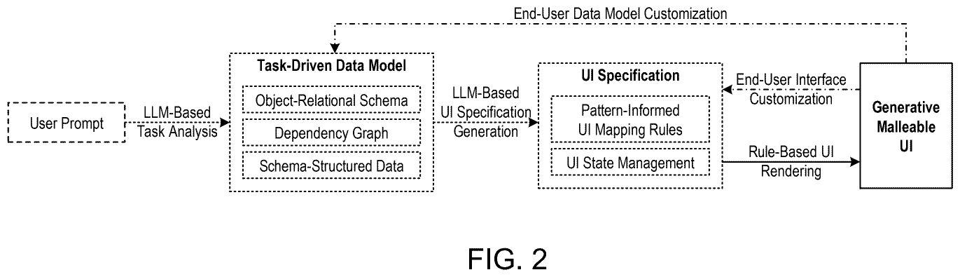

Embodiments of the disclosed technology incorporate the above-described aspects to provide a technical pipeline that takes users' prompts as input and generates corresponding user interfaces, as illustrated in FIG. 2. The pipeline begins by analyzing user prompts to infer user goals and derive sub-tasks. This information is then leveraged by LLMs to generate the Task-Driven Data Model, which represents the structure of the task. The data model is then translated into a UI Specification that defines the composition of UI elements and manages their states. Users can continuously provide natural language prompts and directly manipulate the generated interfaces, which are both translated into corresponding changes to the underlying data model, and subsequently drive real-time updates to the underlying data and/or UIs, resulting in generative and malleable user interfaces. Each component of the pipeline is detailed in the following sections.

### 5.1 Task-Driven Data Model Generation

In some embodiments, the task-driven data model comprises three components: (1) the Object-Relational Schema that describes the types of entities required by the task, as well as their attributes and relationships; (2) the Dependency Graph that describes additional dependency relationships across entities, and (3) Structured Data that instantiates the schema and dependencies with concrete values.

### 5.1.1 Object-Relational Schema

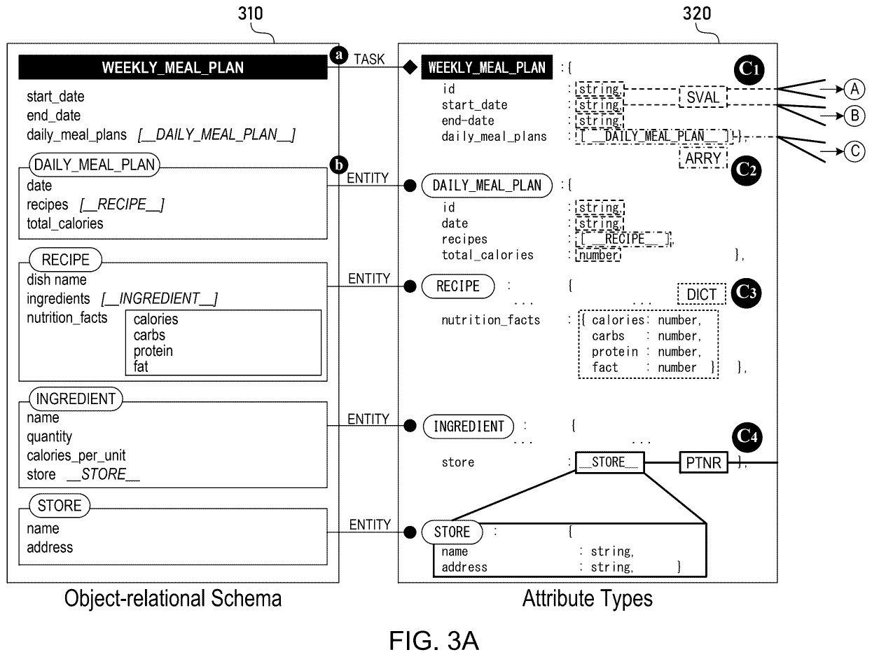

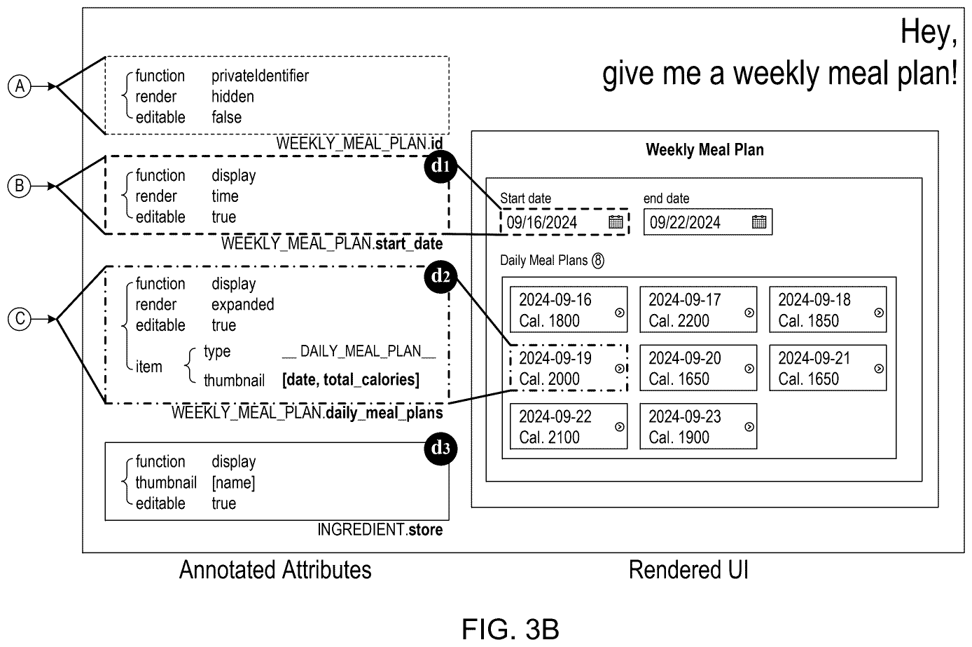

The user task is modeled with an object-relational schema, with which the task and its entities are represented as objects with attributes, and relationships among entities are modeled as references among the objects. FIGS. 3A and 3B show a sample schema generated with the prompt-“give me a weekly meal plan.” A schema consists of the following elements:

Task. The task object is the root of the object-relational schema, which describes the attributes essential to the overall task. For example, the task object of a travel planning task might include attributes such as destination, duration, and itinerary. A meal plan task object might include start/end dates and a daily plan (FIG. 3A, a).

Entity. The schema contains entities that model the essential components of a task. For example, the task of creating a meal plan consists of entities such as daily meal plans, recipes, ingredients, and grocery stores (FIG. 3A, b). In another case, a literature review task might include entities such as paper and author. Each entity contains attributes and cross-references with other entities.

Attribute. Attributes of the task and entity objects are rendered based on their data types, which can be one of the four types:

[SVAL] is a singular data value, such as date, location, etc. (FIG. 3A, c1).

[DICT] is a dictionary that stores key-value pairs, such as the nutrition facts for a dish entity (FIG. 3A, c3).

[PNTR] is a reference to another entity, such as a pointer to a “store” entity in a shopping item (FIG. 3A, c4).

[ARRY] is a collection of items of [SVAL] or [PNTR] type (FIG. 3A, c2). Note that schema syntax does not allow array of [DICT]. If there are multiple entities that share the same [DICT], they will be abstracted as an entity, and their references will be treated as [PNTR]. This abstraction simplifies the data model and ensures consistency in how entities and attributes are handled across the system.

### 5.1.2 Dependency Graph

Dependencies are an essential aspect of complex tasks, which manifest in the UI as relationships between components. The described pipeline uses LLMs to generate these dependencies based on the characteristics of the task, expressed as:

$$Dependency := \{ Source , Target , Mechanism , Relationship \} \qquad ( 1 )$$

Source and Target refer to specific entities or attributes within the object-relational schema.

Mechanism defines how the target reacts to the changes of the source in one of the following two ways: Validate ensures constraints are upheld. For example, the checkout date must be later than the check-in date. If violated, the update of the checkout date value will be rejected, and the UI will highlight the issue to explain the violation to the user. Update automatically propagates changes. For example, the total calories of a dish update automatically if the quantities of the ingredients change.

Relationship defines the relationship between Source and Target. A JavaScript snippet will be generated if the dependency can be expressed by code, e.g., numerical calculations or validations. Otherwise, the relationship is described in natural language, which LLMs can process to apply the effects.

### 5.1.3 Structured Data

Once the schema and dependency graph are defined, the next step is to acquire data that conforms to the specified structure and constraints. The pipeline is designed to support real-time data integration from multiple sources, handling both structured and unstructured data, such as generated data, user-uploaded data, and external APIs (e.g., TripAdvisor for travel or Semantic Scholar for research).

### 5.2 UI Specification Generation

In some embodiments, with the task-driven data model, the pipeline then generates the user interface based on the model. To ensure consistency, stability, and quality of the generated UIs, a specification-based approach is adopted. Therefore, this step of the pipeline takes the data model and generates the UI specification, which guides the composition of the user interface.

5.2.1 Annotating Object-Relational Schema with UI Mapping Rules

Specifically, the pipeline examines each task and entity attribute and annotate each with labels that specify their data types, function roles, and rendering types. The annotations serve as a specification that guides the mapping of schema elements to UI components using a rule-based approach. The full specification and an example is provided in Section 10.

Attributes of [DICT], [PNTR], [ARRY] may take significant screen space if fully rendered. Therefore, care needs to be taken to ensure the appropriate amount of information is presented on the interface through appropriate UI composition to enable progressive disclosure. Below, we describe how each type of attribute will be labeled and how the labels will affect view composition.

[SVAL] is labeled with <function, render, editable> to describe the functional role, the corresponding rendering widget type (e.g., text, time, or location), and if the user may change the value within the GUI. For example, the start_date is labeled as <display, time, true>, which will be rendered as a calendar widget on the interface that can receive user edits (FIG. 3B, d1).

[DICT] itself is not labeled, but all attributes within it will be labeled and directly rendered within [DICT] attribute's parent view.

[PNTR] is labeled with <function, thumbnail, editable> with <function, editable> the same as [SVAL]. <thumbnail> specifies the attributes in the referred entity that should be displayed for each minimized item. For example, the store attribute for every ingredient is a pointer to a store entity (FIG. 3B, d3). When rendering the ingredient item on the UI, it will only show the name of the store as a hyperlink to the full details of the store it points to.

[ARRY] is labeled with <function, render, editable>. The render type for an [ARRY] can be “expanded” or “summary”. When labeled with “expanded”, the list will be fully rendered. When labeled with “summary”, the list will be rendered in a minimized format, only showing the designated summarizing text and corresponding value, e.g., “Total Calories 2100” for a list of dishes. The summarized form, upon clicked, can expand and show the full list (FIG. 3B, d2). The interaction mechanisms used for navigating these collections of objects is further illustrated in Section 6.1.2.

5.2.2 Executing Dependency Graph with UI State Management

The generated dependency mechanisms are executed with corresponding UI state management rules, ensuring that Jelly reliably and consistently handles the logic for the generated UI. The state management unit of the system sandboxes each dependency execution to limit its effects to ensure UI stability, interprets, and executes the updating or validating mechanisms accordingly.

### 5.2.3 UI Rendering

With the specification, the UI rendering process starts with the object-relational schema for the overall task and recursively renders each referred entity and its attributes. Mapping from the specification labels to the UI widgets is handled through a predefined set of rules that ensures consistency across model and data updates.

5.3 Customization with Continuous Prompting

In some embodiments, as users provide follow-up requests to Jelly, the pipeline dynamically updates both the data model and the UI. The system leverages previous prompts and data models as context, querying the LLM to determine the necessary update operations. It first assesses whether the request requires modifications to the schema (e.g., adding, removing, or updating entities or attributes) and/or updates to the data. These requests are then parsed into a sequence of operations specified as:

$$Updater := \{ Target , Action , Specifications \} \qquad ( 2 )$$

The Target refers to the path of the relevant entities or attributes. Action includes operations such as add, remove, and update (for both schema and data), as well as data-specific operations like cluster, filter, and sort. Specifications details the specific changes to be made for the given action, such as the name of the attribute to be added to the target entity schema. Based on this, the LLM generates the necessary operations to update the UIs.

### 5.4 Implementation in Python

An example of the technical pipeline is developed using Python, with the front-end developed in JavaScript using the React framework. To optimize performance, we process independent pipeline requests to LLMs concurrently. For the generation steps, we leverage Anthropic's Claude 3.5 Sonnet and OpenAI's GPT-40 models, selected based on internal performance testing across various pipeline tasks. At each generation step, we incorporate the user's previous request as context. The LLMs are instructed to first infer tasks implied by the user's current prompt, then generate a JSON object in a specified response format. To ensure controlled and accurate outputs, we use few-shot prompting tailored to each step. Additionally, the pipeline performs compatibility checks on the generated schema and data before rendering.

### 6 Jelly: A Generative and Malleable Interactive System

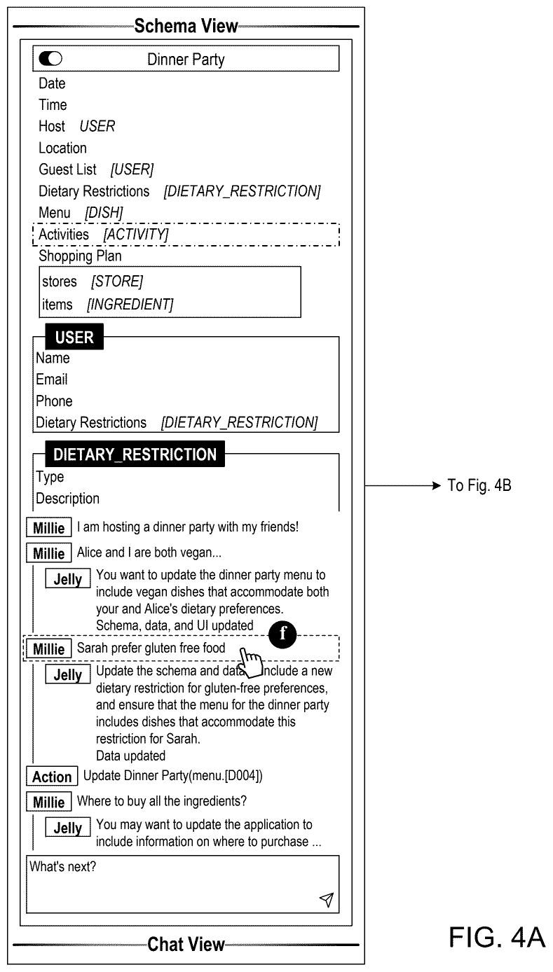

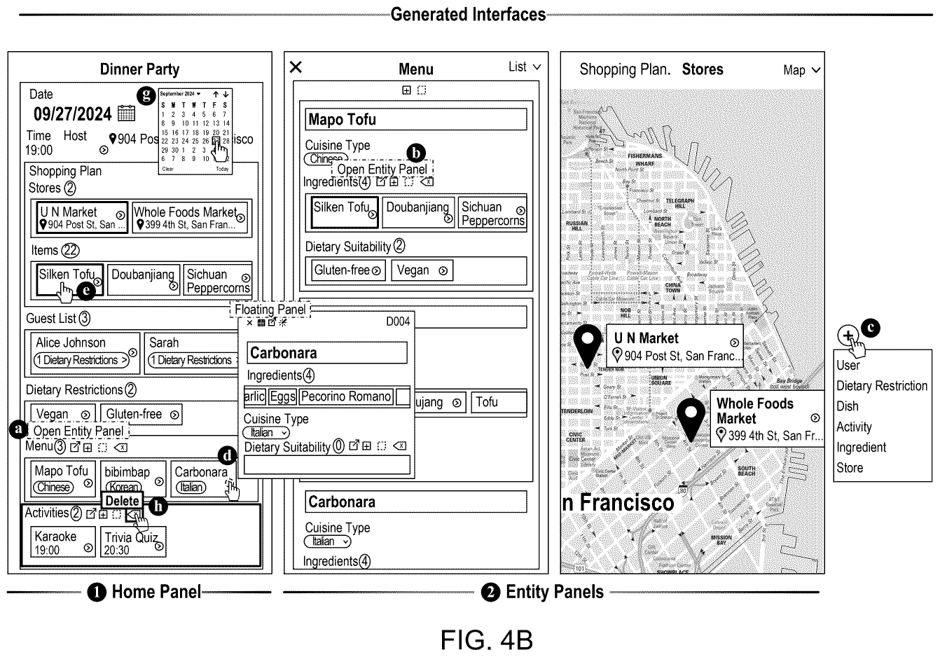

Jelly is a prototype system developed using the technical pipeline described above, and shown in FIGS. 4A and 4B. Users enter Jelly with a prompt that specifies their task. In addition to the main generated interfaces, Jelly's sidebar comprises a Schema View, which surfaces the object-relational data schema; and a Chat View that allows users to provide follow-up prompts, where Jelly responds in natural language about interface changes. In the following sections, we describe the interface designs and interaction techniques in Jelly for effectively supporting users' tasks and customization of the generated UIs.

### 6.1 View Management

User tasks are often supported by complex data models, therefore, presenting all information in a single view can be overwhelming. Jelly employs a set of view management strategies that help users comprehend, navigate, and interact with the generated interfaces.

### 6.1.1 Panels for Showing Task and Entity Objects

The initially generated interface displays only the Home Panel (FIG. 4B, 1), which corresponds to the top-level task object. This provides users with a clear entry point, offering an overview of the task structure.

Each entity within the data model is represented by its own panel (FIG. 4B, 2). Users can navigate to these panels to focus on specific aspects of a task by clicking on the [symbol] icon next to the entity name (FIG. 4B, a). Entity Panels can also be opened within another Entity Panel when there are references between entities (FIG. 4B, b).

Through the use of Jelly, it is recognized that some entities can be deeply nested within others. For example, Dietary Restrictions is not originally displayed in the home panel. Therefore, retrieving all Dietary Restrictions requires navigating through the Dish entity panel first, making accessing and editing these entities cumbersome. To address this, Jelly allows users to view all entities and open their respective panels directly using the [symbol] button (FIG. 4B, c), reducing unnecessary navigation steps.

Additionally, panels can be closed, resized, or rearranged, allowing users to customize their workspaces as needed.

6.1.2 Organizing Collections of Objects within Panels

Given the nested structure of the object-relational schema in our underlying data model, it is important to effectively show collections of objects in the panels. Our design goal is to support users in efficiently navigating complex data structures while maintaining an overview of key information. As described in Section 5.2.1, two rendering types are supported to achieve this:

(1) Expanded rendering presents a full list of items, with each item displaying a subset of attributes most relevant to the task. For instance, in the Dinner Plan panel, the Menu attribute is an array of Dish, displaying as a list of items on the interface, with each item only showing its name and cuisine. Clicking on an item opens a popup card, showing full detailed information, such as ingredients and dietary suitability of the dish (FIG. 4B, d). We choose the popup as a default form of revealing the details for in-situ inspection. Alternatively, users can choose to convert the popup card into a persistent floating card with [symbol] for easy reference; or open it in a dedicated entity panel for a more focused view.

(2) Summary rendering condenses the collection into a single summary button, showing only the most relevant information for the task at hand. For example, in a Shopping Plan, a list of shopping items can be represented as a button showing the total number of Shopping Items, which users can click to reveal and expand into a full list (FIG. 4B, c). Similarly, within a Travel Plan, the Budget may be summarized as the total sum of all expenses, with an option to click and reveal a detailed breakdown.

6.1.3 Cross-referencing with Synchronized Highlighting

As mentioned above, an entity object can have multiple distinct representations within the interface. For example, an Ingredient object may appear in the home panel, and as an item in both the Store and Menu panel (FIG. 4B, e). To facilitate cross-referencing across different views, Jelly implements synchronized highlighting. When users hover over one object, all other objects containing the same instance are highlighted simultaneously. This helps users quickly identify related information across different contexts.

### 6.2 Interaction Techniques for Customization

Jelly allows users to customize the generated UIs with both natural language and direct manipulation, accommodating different types of customization needs.

6.2.1 Continuously Prompting with Traceable History

Users can give follow-up prompts in the chat view to continuously update the data model and the rendered UIs (Section 5.3). Each prompt also serves as an interactive history entry, as it preserves the state of the data model and UI specifications. Users can easily revisit any previous workspaces by clicking on corresponding messages (FIG. 4A, f).

Additionally, any user customization made through the GUI, as described in the following section, is translated into an action-tagged entry. With the traceable history, users can easily switch between different versions of the interface geared towards specific tasks, or revert any changes if there are adjustments that do not meet their expectations.

### 6.2.2 GUI-Based Data Model Customization

While continuous prompting enables users to issue high-level requests and make complex structural changes, Jelly also provides GUI-based direct manipulation for more granular customization of both data and schema elements.

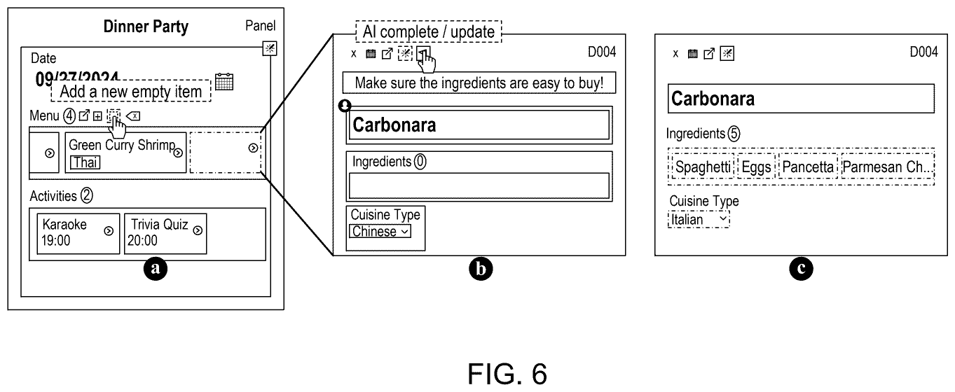

Data Customization. Data in Jelly are editable with suitable representations (FIG. 4B, g). Additionally, the object-oriented underlying structure enables encapsulated actions on entity instances. Users can generate additional instances of an entity (e.g., adding more dishes to a menu) by clicking the [symbol] button. Alternatively, they can add empty instances by clicking [symbol] (FIG. 6, a). This allows them to fill in the values manually. In many cases, users may only know partial attributes of an entity. For example, Millie wants to add Carbonara as a dish for the dinner party, but she does not know the ingredients of it. To support this common need, Jelly provides an auto-complete feature: clicking the [symbol] button allows the user to automatically fill in missing attributes, which also triggers a prompt box at the top of the card, allowing users to specify preferences for the generated attributes (FIG. 6, b-c).

Schema Customization. Beyond data customization, Jelly allows users to directly delete unnecessary attributes using [symbol] button next to the attribute name (FIG. 4B, h). However, adding or modifying attributes currently requires using the continuous prompting in the chat view. The implemented interactions represent only a subset of the possible customization techniques that could be integrated into Jelly. Given the proposed data model and UI specifications, multiple interaction techniques for malleable UIs can be applied here. For example, users could customize which attributes to display in an expanded list when rendering a collection of objects (see Section 6.1.2).

6.2.3 Switching between Representations of Data

Even when using the same schema and data, users may prefer different representations depending on specific tasks. For example, a list facilitates browsing, such as viewing a set of places to visit; a map visualizes spatial relationships for route planning; a table makes it easier to compare attributes across items for decision makings.

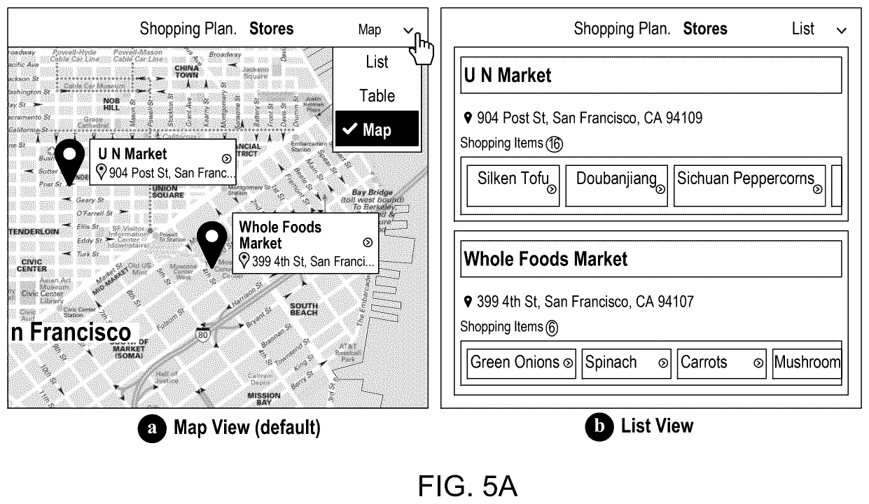

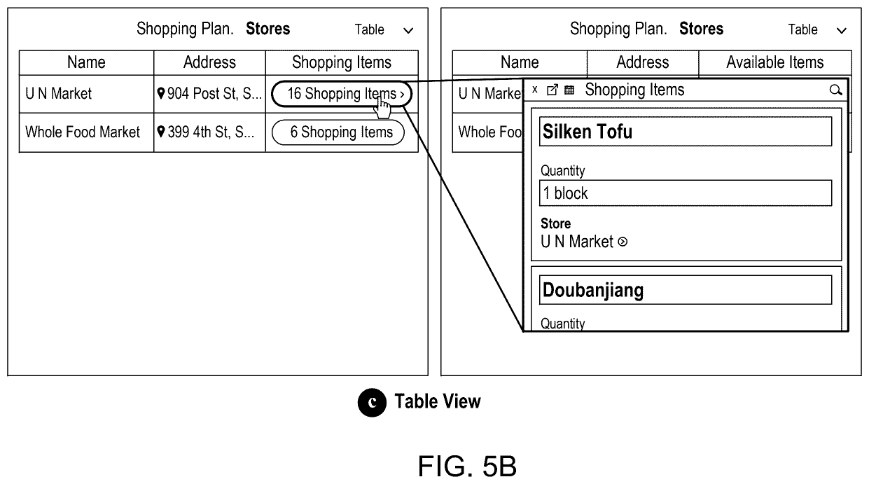

To accommodate this, Jelly allows users to flexibly switch between representations within an entity panel, which displays multiple instances of an entity. Jelly automatically selects the most suitable representation based on the task, and provides a dropdown menu at the top-right of the panel for users to switch at any time (as shown in FIGS. 5A and 5B). While the current implementation only supports list, table, and map views, Jelly's infrastructure allows for easy extension to include other representations, such as timelines, stacks, or even user-defined representations tailored to specific needs.

### 7 Example Technical Evaluation of Jelly

To evaluate the pipeline's ability to generate the task-driven data model based on user requests, a technical evaluation was conducted to assess the quality of the object-relational schema generated by LLMs, in our case, the GPT-40 model, which was used in the pipeline for corresponding modules. Specifically, the following factors were assessed:

Schema Relevance: whether the entities and attributes generated by the system are aligned with the user's task goals and contribute meaningfully to the task's completion.

Dependency Accuracy: (a) the correctness of the relationships between entities, particularly whether the dependencies recognized by the system accurately model task-specific relationships; and (b) whether the corresponding mechanisms (i.e., update or validation) are correct.

UI-specific aspects (e.g., UI components rendering and view composition mechanisms) were not considered in this technical evaluation, as these aspects depend heavily on user interaction.

### 7.1 Setup

Dataset. We employed GPT-40 to generate a set of informational tasks that users might typically require interfaces to complete. The tasks spanned various domains to reflect the generalizability of the system across different informational needs. In total, our dataset comprises 25 task scenarios. To better understand the pipeline's ability to respond to prompts of different levels of detail, for each task, we generated two versions of task prompts—one less detailed and one more detailed, for example:
Less Detailed Prompt: “I want to plan a trip to Tokyo with my friends.”
More Detailed Prompt: “I want to plan a 7-day trip to Tokyo with my friends, for food and cultural experiences.”

This resulted in a dataset of 50 task requests, yielding a total of 197 entities, 1052 attributes, and 232 dependencies in all 50 corresponding data models.

Coding Process. Two coders familiar with database schema and JavaScript programming (for analyzing dependencies) were involved in the evaluation. Each coder inspected the generated data models using the deployed data models and recorded their assessments on a coding sheet. For each task, the coders performed the following assessments:

Schema Relevance: Coders rated the relevance of each entity and attribute on a 4-point scale, ranging from (1) unreasonable (not relevant or redundant), (2) could be useful, (3) necessary and expected, to (4) useful and surprising.

Dependency Accuracy: Coders assessed the dependency relationship among attributes and coded each as Correct, Wrong (e.g., missing or targeting incorrect attributes), or Redundant. Additionally, coders analyzed whether each dependency included correct validation or update relationship mechanism as described in Section 5.1.2 (i.e., correct JavaScript expression or natural language description) and coded each as either Correct or Wrong.

For any discrepancies between the codes of the dependency, a third coder examined the case to resolve the discrepancy.

### 7.2 Results

As shown in Table 1 below, the coding results indicate that the majority of entities (94.12% and 94.74% for less and more detailed prompts) and attributes (93.91% and 95.17% for less and more detailed prompts) inferred by LLMs are necessary and expected. These results demonstrate that the object-relational schema employed in the pipeline can effectively model users' tasks, providing relevant information tailored to their needs. In most cases, LLMs successfully generate meaningful entities and attributes. However, a common issue arises when LLMs interpret prompts too literally, leading to redundant attributes. For instance, in the task “I want to buy a standing desk,” the system might generate an unnecessary “purchase decision” field. However, this only comprises less than 0.5% of the cases.

TABLE 1

| | | Less Detailed Prompts | | | | More Detailed Prompts | | | |
|---|---|---|---|---|---|---|---|---|---|
| Entity | Total | 102 | | | | 95 | | | |
| | Rating | 1 | 2 | 3 | 4 | 1 | 2 | 3 | 4 |
| | C1 | 0% | 3.92% | 96.08% | 0% | 0% | 4.21% | 95.79% | 0% |
| | C2 | 0% | 2.94% | 92.16% | 4.90% | 3.16% | 2.11% | 93.68% | 1.05% |
| | Mean | 0% | 3.43% | 94.12% | 2.45% | 1.58% | 3.16% | 94.74% | 0.53% |
| Attribute | Total | 534 | | | | 518 | | | |
| | Rating | 1 | 2 | 3 | 4 | 1 | 2 | 3 | 4 |
| | C1 | 0.37% | 5.81% | 93.63% | 0.19% | 0% | 0.97% | 94.59% | 0.97% |
| | C2 | 0% | 2.62% | 94.19% | 3.18% | 0.97% | 1.93% | 95.75% | 0.77% |
| | Mean | 0.19% | 4.22% | 93.91% | 1.69% | 0.49% | 1.45% | 95.17% | 0.87% |

Results of the dependency labeling in Table 2 show an average accuracy of 91.5% for relationship and 96.9% for mechanism. We identified two common errors: reversed relationships, where the relationships reverse the source and target, and redundant dependencies, where the dependencies describe relationships that are already declared in the schema with the referencing attributes. Although these dependency issues do not significantly impact the overall effectiveness of the pipeline and can often be identified through the GUI or corrected with improved prompting or validation, they highlight areas for improvement in how dependencies are inferred and generated. When using LLMs to establish directional relationships, validation is necessary to ensure accuracy, which we have integrated into our pipeline.

TABLE 2

| | Less Detail Prompts | | | More Detail Prompts | | |
|---|---|---|---|---|---|---|
| Total | 120 | | | 112 | | |
| Rating | Correct | Wrong | Redun- | Correct | Wrong | Redun- |
| | (C) | (W) | dant | (C) | (W) | dant |
| | | | (R) | | | (R) |
| Relationship | 89.17% | 5.83% | 5.00% | 93.75% | 1.79% | 4.46% |
| Mechanism | 98.33% | 1.67% | n/a | 95.54% | 4.46% | n/a |

### 8 Example User Study

A user study was conducted to gain a comprehensive understanding of the pipeline's capability in responding to real-world user requests, the effectiveness of the generated UIs, and the novel workflows and limitations that may emerge from the study. Specifically, the following questions were considered:
(1) Do the generated UIs effectively present information in a way that helps users accomplish their tasks?
(2) How easily and effectively can users customize and modify the UIs to adapt to their evolving tasks and needs?
(3) What is the user experience of interacting with a generative and malleable information space, and how does it compare to existing interfaces such as chat-based systems and traditional GUI-based apps?
(4) What challenges do users encounter when generating and adapting the UIs to suit their needs? Are these challenges primarily due to the limitations of the generation pipeline or the interaction mechanisms?

### 8.1 Participants

Eight participants were recruited (5 female and 3 male, aged 21-28) through the internal communication channels within a large public university. Participants, including students and research scientists, reported that they use diverse information systems in their daily life and work. All of them use generative AI tools (e.g., ChatGPT) on a daily basis.

### 8.2 Study Procedure

The study lasted approximately 80 minutes per participant. Seven sessions were conducted in person and one remotely via Zoom. For all sessions, the experimenter provided verbal instructions, and the participants interacted with the system by following the experimenter's instructions. All sessions were screen- and voice-recorded. Participants were provided with a consent form, which they reviewed and signed before the study. Participants received a 30 USD Amazon gift card for their participation. The study was divided into the following phases:

Introduction (5 minutes). Participants were first given a brief introduction to the research and an overview of the system, including the different parts of the interface and their functionality.

System Walk-through/Tutorial (15 minutes). Participants were guided through an example task—hosting a dinner party, where they interacted with the system to request information, modify the UIs, and explore customization options. Participants performed the interactions themselves while the experimenter provided guidance, helping them familiarize themselves with the system's capabilities before moving on to freeform tasks.

Freeform Tasks (2 tasks, each 20 minutes). Participants were asked to use the system to complete two tasks of their choice. During each task, participants were encouraged to make various requests, evaluate the interface generated by the system, and reflect on whether the interface met their needs. They were instructed to create at least two follow-up queries per task to assess how well the system supported UI modifications.

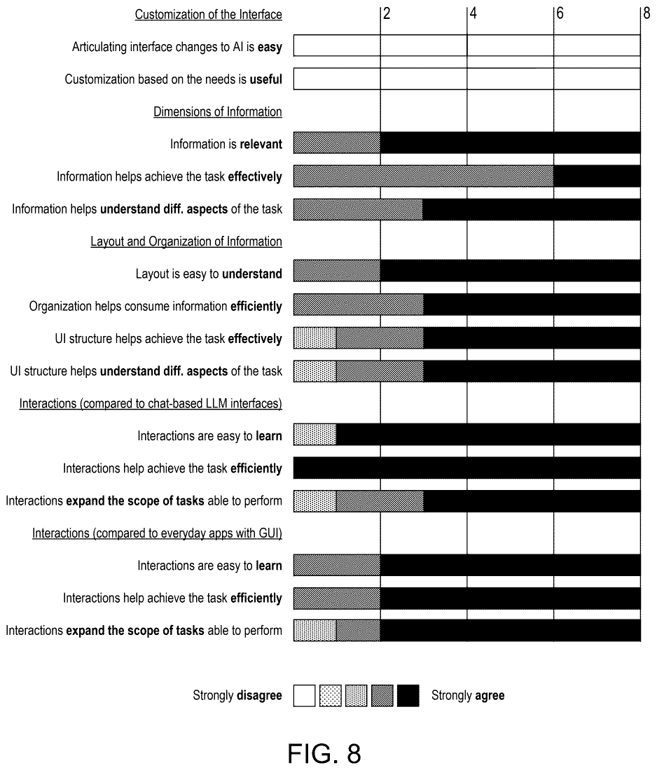

Questionnaire and Interview (20 minutes). After completing the tasks, participants filled out a 5-point Likert scale questionnaire evaluating different dimensions of the system and their overall experience. The results of the questionnaire are illustrated in FIG. 8. A semi-structured interview was also conducted to gather in-depth qualitative feedback.

### 8.3 Results

The results of the questionnaire, interview, and user behavior analysis for the freeform tasks are summarized in this section.

Questionnaire Results. The questionnaire targeted assessing the utility and effectiveness of the generated information, the layout of the interface, and the interactions with Jelly through prompting and direct manipulation (RQ1, RQ2). The results show that participants generally found the information presented on the interface relevant (6 strongly agree, 2 agree) and can help them achieve their tasks efficiently (2 strongly agree, 6 agree). Being able to express their personal needs and customize the interface accordingly is found to be easy (4 strongly agree, 4 agree) and useful (6 strongly agree, 2 agree). The panel layout and organization of information were found to be intuitive (6 strongly agree, 2 agree) and effective for information consumption (5 strongly agree, 2 agree, 1 neutral). Full questionnaire results can be found in Appendix B.

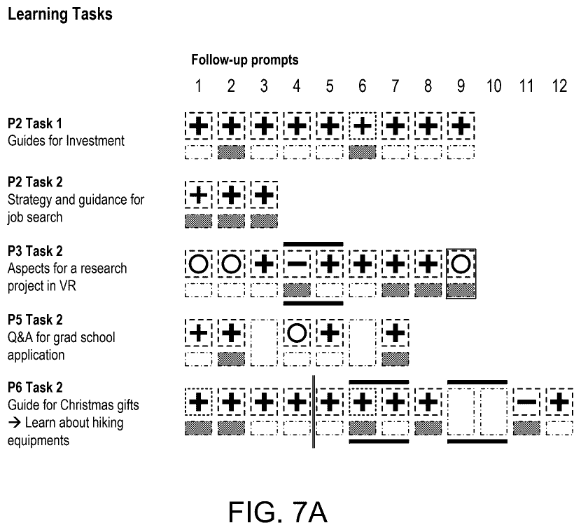

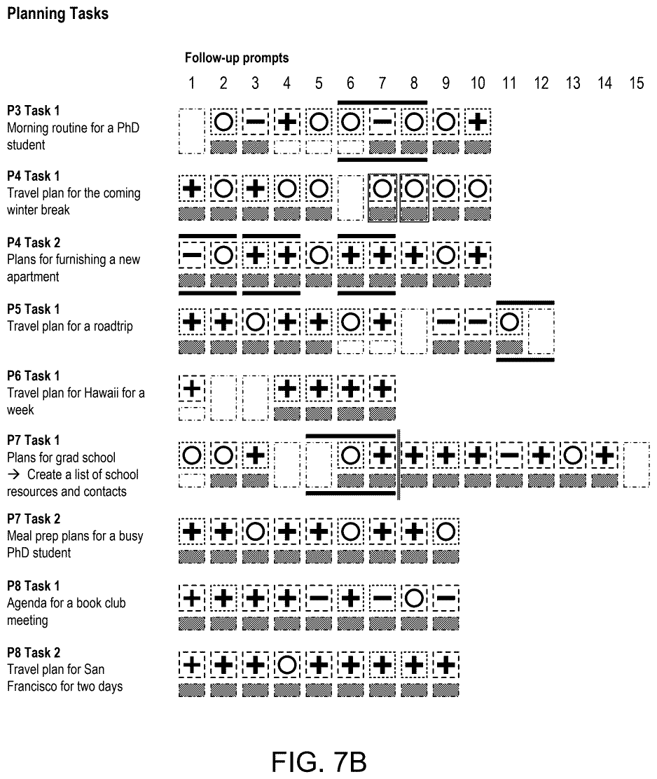

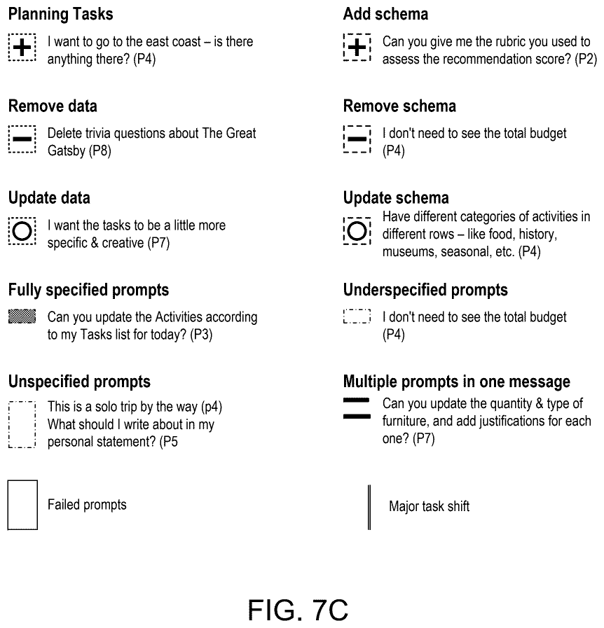

Open-Ended Tasks and Interaction Behaviors. To better understand how users achieve their freeform tasks with the task-driven, model-based UIs (RQ3, RQ4), we logged and analyzed participants' follow-up chat messages with Jelly for continuous customization of the interface (as shown in FIGS. 7A-7C). We analyzed 14 out of 16 tasks (2 tasks missing due to the loss of P1's data), which included 120 follow-up messages. Occasionally, a single chat message contained multiple prompts with distinct requirements or pieces of information (see the example in FIGS. 7A-7C). We separated these prompts from the chat messages, which resulted in a total of 131 prompts.

The prompts participants initiated were categorized into Learning Task and Planning Task. The follow-up prompts are classified based on the intended updates of the data model—either the data or the schema—and the level of specificity. The logged results are visualized in FIGS. 7A-7C, with details reported below.

Prompt Specificity. We expect Jelly to handle user prompts across varying levels of specificity. If a prompt specifies both target and action of the expected schema or data change (Section 5.3), e.g., “Add weather to the homepage” (P8), it is coded as fully specified. If either or both aspects are missing, a prompt is considered underspecified, e.g., “Give me weather information” (P6). Sometimes, participants may broadly ask for strategies, e.g., “What should I write about in my personal statement?” (P5); or simply provide contextual information, such as “This is a solo trip by the way” (P4). These prompts do not provide any indication of how the UI should change. We code these prompts as unspecified prompts.

Participants made a total of 91 fully specified prompts (69%), 27 underspecified prompts (21%), and 13 unspecified prompts (10%). Our results show that when participants prompt the system to adapt to their needs, they tend to be more specific on planning tasks (82% fully specified, 8% underspecified, 10% unspecified) than learning tasks (35% fully specified, 55% underspecified, 10% unspecified).

Modification Patterns. Participants issued a total of 118 fully specified or underspecified prompts to Jelly to express the desired changes to either the schema or the data to adjust the UIs to their needs. Among these, 86 were schema changes (57 adds, 10 removes, 19 updates), and 32 were data changes (19 adds, 1 remove, 12 updates), indicating participants mostly sought to expand the scope of information or request additional data throughout the tasks.

The results also show different modification patterns on the two types of tasks: during learning tasks, participants primarily engaged with schema modifications (92% schema changes, 8% data changes), whereas in planning tasks, the need for data modifications was significantly higher (65% schema changes, 35% data changes).

Failure Cases. While Jelly was able to effectively interpret most user prompts and make corresponding schema and data changes, it occasionally failed during the study (a total of 3 times among 120 follow-up messages). Three failure cases are reported:
Case 1: Jelly was unable to handle P3's request to customize the visual style of the UIs: “Can you make the text size smaller?” As a result, no schema or data change was made.
Case 2: P4 requested more acivities of different types to be displayed in separate rows, expecting Jelly to create a set of lists, each containing a type of activity. Instead, Jelly added a “type” attribute to all existing activities, failing to meet the intended outcome.
Case 3: After observing the error in Case 2, P4 repeated the same request. However, Jelly maintained the same UI without implementing the desired changes.

### 8.4 Additional Results

All participants expressed excitement about being able to generate an information space tailored to their needs. The iterative customization experience was perceived “fun” (P2, P7) and “efficient” (P2, P4), allowing them to have an interface that “reflects their needs along the way” (P2). We discuss key findings and takeaways below.

Effective Information Organization for Task Achievement. The above-discussed results revealed participants found the structured information in Jelly helped them effectively achieve their tasks. Participants also noted that they appreciated the system's ability to extend beyond their direct prompts and generate “reasonable surprises” that supported their goals (P4, P6). For example, when P4 requested new furniture for their living room planning task, Jelly went beyond the prompt and grouped furniture based on aesthetic themes and suggested corresponding vendors. They were fond of the unexpected grouping of furniture into “Bohemian” and “Earth-toned” categories, noting how it mirrored their aesthetic preferences and saved their efforts in creating such groupings manually. Moreover, Jelly commonly leveraged semantic linkages among those attributes with the proposed pipeline to streamline certain workflows. For example, when P7 requested dietary restrictions for all guests, Jelly not only applied those restrictions but also removed dishes that violated them, effectively anticipating the user's needs.

Takeaway: The structured organization and semantic associations enabled by the object-relational schema effectively present and manage LLM's open-world knowledge to be easier to consume and control by the end-users.

Continuous Customizability and Flexible Adaptation to User Needs and Tasks. One of the standout features of Jelly was its ability to accommodate continuous, iterative customization. P6 noted that many other tools offer “one-shot” customization, where users make changes that are meant to be permanent. Jelly's continuous adaptability allowed the users to adjust their workflows dynamically without being locked into a specific configuration. For example, P8 noted that they often struggled to decide which applications to use and had to manually collect information from multiple sources into different note-taking tools. With Jelly, they could bypass the overhead of debating and selecting suitable applications as well as juggling multiple applications. They felt confident knowing they could always request Jelly to provide the desired information as new needs arose.

We observed participants naturally shifted focuses or changed task scopes when performing tasks with Jelly. For example, P6's task transformed from preparing Christmas gifts to learning and planning for a hiking trip, and P7 began with planning for settling into graduate school, which eventually scoped down to creating a list of school resources and managing their contacts. This fluidity was enabled by Jelly's continuous customization, allowing participants to transition between evolving information needs without disrupting their current workflows.

Jelly's ability to interpret ambiguous prompts and leverage contextual information allowed participants to comfortably begin with vague inquiries and refine their goals as they interacted with the system. This was particularly beneficial when exploring unfamiliar domains. For example, during a trip to Hawaii, P6 stated, “I want to stay on the beach,” without a clear idea of how this preference would impact their plans. They simply made the request out of curiosity to see how Jelly would handle it. In response, Jelly generated a list of beachfront hotels along with suggested beach activities, which inspired them to explore and plan different activities for the trip.

Participants also commented on the traceable history in the chat view, which allowed them to easily revisit previous states, especially when AI-generated changes did not fully align with their needs.

Takeaways: Users' intentions naturally shift and evolve during information tasks, varying in specificity. A system's ability to accommodate the varying levels of specificity and continuously adapt is essential for supporting fluid information activities. By leveraging LLMs' capacity to interpret flexible inputs and task-driven, model-based UI generation, and efficiently accomplish tasks.

Task-Driven Data Model: Malleable but Persistent Structures [RQ3]. Compared to chat-based systems and traditional apps, Jelly was seen as providing a novel, more fluid experience that combined the best of both worlds. The persistence and flexibility of the data model was considered beneficial in maintaining continuity with evolving tasks and able to offer desired interactions with the information they needed for the tasks (8 strongly agree).

Unlike existing chat-based interfaces with LLMs (e.g., ChatGPT), where responses primarily generate content, P6 noted that Jelly was “generating the way to organize information.” Participants also appreciated being able to make localized adjustments to a particular part of the interface-such as adding or editing a field-without needing to issue a full reset or restructuring of the entire layout, which is often the case in existing LLM-based generative systems (P2, P4). Moreover, the structure enabled users to modify and carry data seamlessly across ongoing tasks, reducing the need for copy-pasting and manual adjustments typically required in chat-based systems. Transparency was another key advantage of the model-driven approach, giving participants confidence that their task structures remained intact rather than being unpredictably altered by AI. As participants became more familiar with Jelly, they actively engaged with the schema view to explore and understand AI's modifications. For example, when P6 requested daily weather information for their itinerary, they first checked the schema view to confirm that the itinerary schema had been extended before switching back to the UI view to verify the changes.

Compared to existing apps, participants appreciated the absence of “opinionated” design choices that restrict customization (6 strongly agree, 1 agree, 1 neutral). P4 described situations where they could often achieve 80% of their desired functionality in existing apps, but the inability to make small, yet necessary, modifications for specific use cases was frustrating-such as splitting road trip costs in a collaborative travel planning application. P6 further elaborated that existing apps “force everyone to see all the information,” whereas Jelly allowed users to view only what was relevant to them. This ability to “own my data” and structure it according to personal preferences was seen as one of the major strengths (P6).

Takeaways: Continuity and transparency are essential for a generated interface to effectively meet users' task needs. Anchoring the generation process to the flexible, task-driven data model ensures these qualities, enabling users to adapt structures to their preferences and maintain confidence in the UI modifications.

Expecting More Efficient Ways to Interact with the Model and UIs. One challenge of the current implementation of Jelly was the need for continuous prompting to make incremental changes for most of the cases. While all participants acknowledged that it was easy to articulate intended changes to AI (4 strongly agree, 4 agree), P1 and P8 noted that it could be tedious to describe every requirement in detail when the system failed to initially generate a sufficient task structure. A potential improvement is to generate the model along with possible expansions to it (e.g., additional entities and attributes to consider), which would enable users to quickly expand the model with lightweight interaction.

Three participants (P3, P6, and P7) found the schema view useful for inspecting the underlying structure and understanding the changes, while others mainly relied on the generated UI for their tasks. P4 suggested that enhancing interactions for manipulating the schema directly could be particularly beneficial for developers. For example, P4 expressed a desire to “cherry-pick” elements from one schema as the starting point for another session. This also points to a potential future direction for making schema composable and reusable to enable users to create new spaces from existing ones, facilitating cross-domain tasks.

Additionally, the generated UIs in Jelly incorporated a limited set of design patterns within its specifications, restricting the expressiveness of information presentation and interactions. For example, P2 expressed the desire to have a line chart visualization of stock information, which was beyond the scope of our system's current UI specifications. This limitation highlights the need for a more comprehensive UI specification to enhance information representation and interaction (e.g., diverse layouts, advanced interaction logic), which we discuss further in the following section.

Takeaways: Efficiency of information acquisition and expressiveness of UIs are desired by the users. While continuous prompting offers flexibility, more proactive model expansion and light-weight refinement mechanisms are needed for achieving composable and reusable UIs to further adapt to evolving task needs. Enhancing UI design patterns and expanding UI specifications would further improve information expressiveness and usability.

### 9 Example Embodiments of the Disclosed Technology

In some embodiments, the technical pipeline models the dependencies required in an information task by describing the relationships among pairs of source and target elements. While this relatively simple mechanism yields few errors in our technical evaluation and is sufficient in supporting study participants in completing their intended tasks, it also has limitations in describing tasks that require complex interaction. To that end, more advanced graph-based dependency modeling, where nodes of the graph represent entities and attributes, and the edges represent the dependency relationships expressed using a more expressive specification language are deployed. This dependency graph not only allows for the modeling of interaction logic beyond pairs of elements but also enables end-users to intuitively inspect the dependencies by leveraging representation and interaction techniques introduced in graph-based visual programming.

In some embodiments, the current schema operations (e.g., add, delete, and update) can theoretically handle all possible schema transformations, but having to translate high-level transformations to these low-level operations can lead to complex and error-prone data and UI modifications-especially when LLMs are involved in the process. High-level transformations, such as eversion, are commonly needed but difficult to express with atomic operations. For example, a user might start by viewing a list of literature modeled as an Publication entity containing attributes like title, authors, and year. Later, they might wish to transform this view to focus on all Authors and their respective publications. Using current schema operations, the system would need to generate a new entity, likely resulting in substantial changes to both the UI and underlying data. To that end, a dedicated eversion schema operation from the Publication entity to the Author entity can be used to ensure a smooth data and UI transformation. For example, users' prompts with the system can be analyzed to identify the desired high-level transformations and expand the schema operations to support them more directly.

In some embodiments, the Jelly implementation employs a column-based layout to organize the panels on the screen, and can be configured to integrate the underlying data model with the dashboard design pattern, which summarizes the key dimensions that guide the placement and presentation of information panels. Concretely, entities and lists of entities can be displayed in separate panels, arranged based on inferred importance-such as the number of attributes or connections to other entities. Key panels can occupy central positions with detailed information, whereas less critical ones might be placed along the periphery with more condensed views. Certain entities may benefit from being displayed with multiple synchronized representations (e.g., a table and a map). In these embodiments, diverse representations of information within each panel are supported, thereby enhancing Jelly's expressivity in the graphical representation of information.

In some embodiments, the technical pipeline is extended to interface with external data sources and user-permitted data beyond just relying on LLM-generated data. Recent approaches of integrating LLMs with external data-such as Retrieval-Augmented Generation, the Model-Context Protocol, and LLM-generated API calls-offer different ways of integrating reliable data sources into the technical pipeline. These embodiments can be implemented with different data schema: The benefit of a persistent schema employed by traditional applications is that it may be optimized based on data storage and retrieval efficiency. The dynamic data schema that drives the interface may not directly mapped to the underlying database schema.

Personalized interfaces have been a long-standing endeavor in activity-centered computing, which require not only customization but also context preservation. In some embodiments, and unlike most existing interfaces that remain the same regardless of who uses them and for how long, the disclosed technology enables the underlying data model and the generated UIs to be personalized and intelligently tailored to each individual context and preference over time. Herein, adaptability and predictability are balanced. An interface that adapts too aggressively may make incorrect assumptions about user intent, leading to frustration; conversely, an interface that requires excessive manual configurations, shifts too much burden on the user. These embodiments leverage the insight that achieving context-aware UIs requires an intermediate representation that effectively preserves and reuses user context and hence guides adaptation.

In some embodiments, Jelly can record users' preferred entities, attributes, and interface configurations for different tasks. When a user encounters new tasks, it can intelligently reuse subcomponents from previous relevant tasks. For example, if a user is organizing an academic workshop for the first time, the system could adapt UI elements from workspaces of past activities, such as scheduling talks (as in conference planning) or coordinating a dinner event (as in family gathering). Besides model reuse, these embodiments implement personalized model evolution. Different users may prioritize different aspects of their workflows—a researcher may focus on entity relationships when conducting a literature review, while a project manager may emphasize task dependencies and deadlines. Thus, in these embodiments, users can inspect and customize the context being preserved and adapted, achieving an information space that is not only generative, malleable, but also personal.

Embodiments of the disclosed technology are based on the perspective that a GUI-based interactive system is the graphical representation of the data model that describes the targeted user tasks, and that generative and malleable user interfaces fundamentally demand generative and malleable data models to support users' dynamic tasks. Accordingly, the described embodiments leverage LLMs to generate task-driven data models based on the tasks indicated in users' prompts, which then guide the generation of the user interface. Results from the technical evaluation show that LLMs can generate relatively high quality data models. The user evaluation of the system shows that the generative and malleable user interfaces enable users to develop a personalized and dynamic information space by flexibly curating diverse information and customizing its representation.

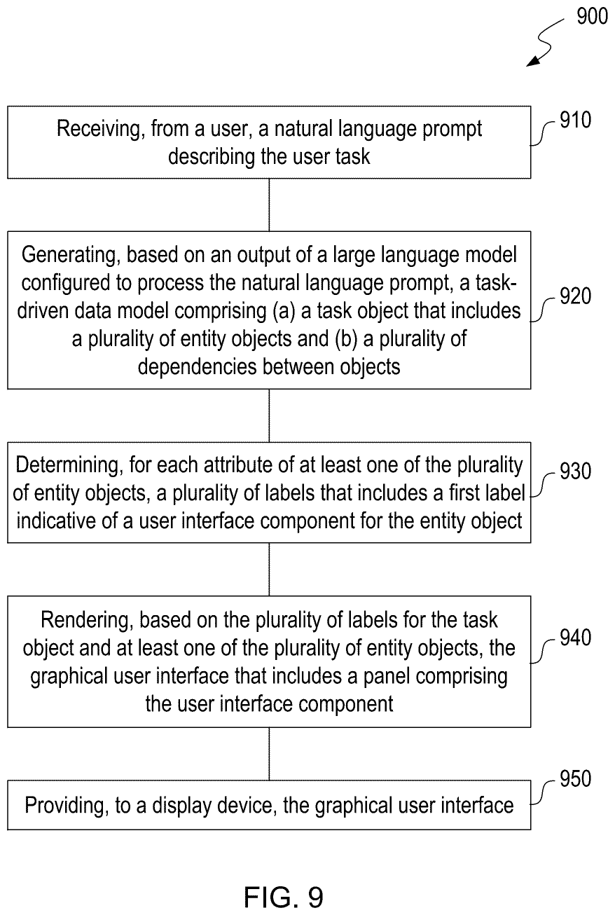

The various above-described aspects of generative and malleable UIs are highlighted in the following technical solutions:
S1. A method (e.g., method 900 illustrated in FIG. 9) of generating a graphical user interface for a user task, comprising: receiving (910), from a user, a natural language prompt describing the user task; generating (920), based on an output of a large language model (LLM) configured to process the natural language prompt, a task-driven data model comprising (a) a task object that includes a plurality of entity objects and (b) a plurality of dependencies between objects, wherein the task object is representative of the user task and each of the plurality of entity objects is representative of a goal or a sub-task of the user task, and wherein an entity object is associated with an attribute that identifies the entity object as comprising a singular data value, an array of singular data values, a pointer to the entity object, an array of pointers, or a key-value dictionary pair, wherein a dependency comprises a source object, a target object, a mechanism that either validates a constraint between the source object and the target object or updates the target object based on a change in the source object, and a relationship between the source object and the target object; determining (930), for each attribute of at least one of the plurality of entity objects, a plurality of labels that includes a first label indicative of a user interface component for the entity object; rendering (940), based on the plurality of labels for the task object and at least one of the plurality of entity objects, the graphical user interface that includes a panel comprising the user interface component; and providing (950), to a display device, the graphical user interface.
S2. The method of solution S1, wherein the plurality of labels further includes a second label indicative of a data type of the entity object, a third label indicative of the attribute being an identifier, and a fourth label indicative of the user interface component being editable, and wherein the plurality of labels is determined based on a plurality of one-to-one mappings.
S3. The method of solution S1, wherein the relationship between the source object and the target object is expressed using a code snippet or a natural language expression.
S4. The method of solution S1, further comprising: receiving, from the user, a modification to the user task; identifying, based on the plurality of dependencies, one or more entity objects or attributes that are affected by the modification to the user task; and re-rendering the graphical user interface to update panels associated with each of the one or more entity objects or attributes.
S5. The method of solution S4, wherein another natural language prompt or a manipulation of the graphical user interface is indicative of the modification to the user task.
S6. The method of solution S1, wherein a type of the user interface component and the first label is determined based on a size of a screen of the display device.
S7. The method of solution S1, wherein the panel can be closed, resized, or repositioned on the graphical user interface.
S8. A system for generating a graphical user interface for a user task, comprising: one or more processors configured to: receive, from a user, a natural language prompt describing the user task, generate, based on the natural language prompt, a task-driven data model comprising (a) a task object that includes a plurality of entity objects and (b) a plurality of dependencies between objects, wherein the task object is representative of the user task and each of the plurality of entity objects is representative of a goal or a sub-task of the user task, and wherein an entity object is associated with an attribute that identifies the entity object as comprising a data structure, wherein a dependency comprises a source object, a target object, a mechanism that either validates a constraint between the source object and the target object or updates the target object based on a change in the source object, and a relationship between the source object and the target object; determine, for the task object and at least one of the plurality of entity objects, a plurality of labels that includes a first label indicative of a user interface component for the entity object, render, based on the plurality of labels for the task object, a home panel, and render, based on the plurality of labels for at least one of the plurality of entity objects, at least one entity panel comprising the user interface component; and a display device configured to visually present, to the user, the graphical user interface comprising the home panel and the at least one entity panel.
S9. The system of solution S8, wherein the data structure comprises a singular data value, an array of singular data values, a pointer to the entity object, an array of pointers, or a key-value dictionary pair.
S10. The system of solution S8, wherein the one or more processors is further configured to: receive, from the user, an input indicative of a modification to the user task; parsing the input to identify one or more entity objects or attributes that are affected by the modification to the user task and an action comprising a task-level operation or a data-specific operation; and re-rendering, based on the action and the one or more entity objects or attributes, one or more entity panels corresponding to the one or more entity objects or attributes.
S11. The system of solution S10, wherein the task-level operation comprises adding a new entity object, removing an existing entity object, or updating the existing entity object, and wherein the data-specific operation comprises updating data in the existing entity object.
S12. The system of solution S8, wherein the data structure associated with the at least one entity panel can be represented in the graphical user interface using a map view, a list view configured to display one or more details of data in the data structure, or a table view configured to display a summary of the data in the data structure.

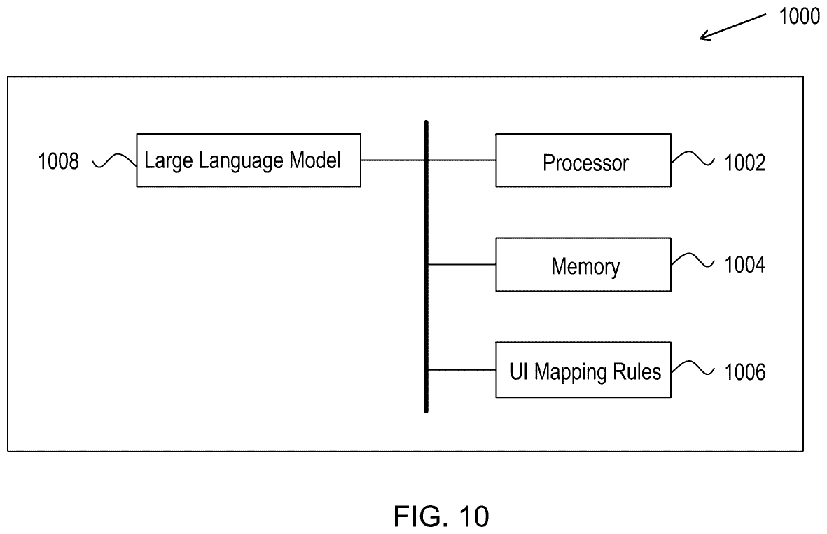

FIG. 10 shows an example of a hardware platform 1000 that can be used to implement some of the techniques described in the present document and appendices. For example, the hardware platform 1000 may implement the various modules and algorithms described herein. The hardware platform 1000 may include a processor 1002 that can execute code to implement a method. The hardware platform 1000 may include a memory 1004 that may be used to store processor-executable code and/or store data. The hardware platform 1000 may further include UI mapping rules 1006 and a large language model (LLM) 1008, which can communicate with the processor 1002. In some embodiments, the processor 1002 may include one or more processors implementing at least a portion of the UI mapping rules 1006 and the LLM 1008. The processor 1002 may be configured to implement data schema generation and other UI rendering operations. In some embodiments, the memory 1004 may include multiple memories, some of which are exclusively used by the processor 1002 when implementing the data schema generation and/or other UI rendering operations.

### 10 Example UI Specifications

An example UI specification is shown in Table 3 below.

TABLE 3

| Key | Value | Explanation |
|---|---|---|
| type | string | The data type of the value, which can be a string, number, |
| | number | array, or the name of an entity, for which we use |
| | array | _<ENTITY>_ to annotate, e.g., _PERSON_{—} |
| | _<ENTITY>_{—} | |
| function | priviateIdentifier | The attribute functions as a unique identifier of an object |
| | | used internally by the Jelly system. Private identifiers may |
| | | not be semantically meaningful to the user and should not |
| | | be displayed in the interface |
| | publicIdentifier | The attribute functions as a representative identity of an |
| | | object, such as name and title. Public identifiers should be |
| | | displayed with the highest saliency when rendering the UI |
| | | for the object |
| | display | All other attributes of the object |
| editable | true or false | Whether the user is allowed to modify the value of the |
| | | attribute in the rendered UI |

When the type of the attribute is not array . . .

| | | |
|---|---|---|
| render | shortText | Short pieces of text, e.g., name of a hotel, title of a book |
| | paragraph | Long blocks of text, e.g., description of a city, review |
| | | of a product |
| | number | Numeric values, including integers, floats, percentages, etc. |
| | url | Links to websites, e.g., https://hci.ucsd.edu |
| | time | Temporal values, such as dates, specific points in time, |
| | | durations, etc. |
| | location | Geographic coordinates or names of places |
| | category | One of the categories defined by the categories field as a |
| | | list of strings in the attribute specification |
| | hidden | The attribute will not be rendered |

When the type of the attribute is array . . .

| | | |
|---|---|---|
| render | summary | The array is minimized as a single button showing one key |
| | | aspect of the items in the array (see below for how it's |
| | | derived). The full array shows upon clicked |
| | expanded | The array is fully shown, and the user can directly see, |
| | | scroll through, and interact with each item |
| item | type | The type of the items in the array, same as type for the |
| | | attributes |
| | thumbnail | An array of attribute names. If the item type is an entity, we |
| | | need a set of representative and relevant attributes when |
| | | displayed in a minimized form in the array (default to |
| | | publicIdentifier) |
| (summary) | {name, derived} | Only for the summary render type. The target attribute of |
| | | the array items (name) and the method for deriving the |
| | | summarizing value from them (derived). derived is an |
| | | object of two keys, field and operation. If field is a number, |
| | | operation could be SUM, AVG, MIN, or MAX; or FILTER or |
| | | COUNT if field is an array |

Another example UI specification is shown below.

| | |
|---|---|
| 1 | { |
| 2 | DINNER_PLAN: { |
| 3 | id: { type: “string”, editable: true , render: “hidden”, function: “private Identifier” }, |
| 4 | date: { type: “string”, editable: true , render: “date”, function: “display” }, |
| 5 | host: { type: “_{——}USER_{——}”, editable: true , render: “short Text”, function: “display” }, |
| 6 | location: { type: “string”, editable: true , render: “location”, function: “display” }, |
| 7 | guest_list: { |
| 8 | type: “array”, |
| 9 | editable: true , |
| 10 | render: “expanded”, |
| 11 | item: { type: “_{——}USER_{——}”, thumbnail: [“name”, “phone”] } |
| 12 | }, |
| 13 | menu: { |
| 14 | type: “array”, |
| 15 | editable: true , |
| 16 | render: “summary”, |
| 17 | summary: { |
| 18 | name: “total_calories”, |
| 19 | derived: { operation: “SUM”, field: “calories” } |
| 20 | }, |
| 21 | item: { type: “_{——}DISH_{——}”, thumbnail: [“name”, “calories”] } |
| 22 | } |
| 23 | }, |
| 24 | USER: { |
| 25 | id: { type: “string”, editable: true , render: “hidden”, function: “private Identifier” }, |
| 26 | name: { type: “string”, editable: true , render: “short Text”, function: “public Identifier” }, |
| 27 | email: { type: “string”, editable: true , render: “url”, function: “display” }, |
| 28 | phone: { type: “string”, editable: true , render: “number”, function: “display” } |
| 29 | }, |
| 30 | DISH: { |
| 31 | id: { type: “string”, editable: true , render: “hidden”, function: “private Identifier” }, |
| 32 | name: { type: “string”, editable: true , render: “short Text”, function: “public Identifier” }, |
| 33 | ingredients: { |
| 34 | type: “array”, |
| 35 | editable: true , |
| 36 | render: “expanded”, |
| 37 | item: { type: “string”, editable: true , render: “short Text”, function: “display” } |
| 38 | }, |
| 39 | calories: { type: “number”, editable: true , render: “number”, function: “display” }, |
| 40 | cuisine_type: { |
| 41 | type: “string”, |
| 42 | editable: true , |
| 43 | render: “category”, |
| 44 | function: “display”, |
| 45 | categories: [“American”, “Italian”, “Chinese”, “Japanese”, “French”] |
| 46 | } |
| 47 | } |
| 48 | } |

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described, and other implementations, enhancements and variations can be made based on what is described and illustrated in this patent document.

What is claimed is:

1. A method of generating a graphical user interface for a user task, comprising:
receiving, from a user, a natural language prompt describing the user task;
generating, based on an output of a large language model (LLM) configured to process the natural language prompt, a task-driven data model comprising (a) a task object that includes a plurality of entity objects and (b) a plurality of dependencies between objects,
wherein the task object is representative of the user task and each of the plurality of entity objects is representative of a goal or a sub-task of the user task, and
wherein an entity object is associated with an attribute that identifies the entity object as comprising a singular data value, an array of singular data values, a pointer to the entity object, an array of pointers, or a key-value dictionary pair,
wherein a dependency comprises a source object, a target object, a mechanism that either validates a constraint between the source object and the target object or updates the target object based on a change in the source object, and a relationship between the source object and the target object;
determining, for each attribute of at least one of the plurality of entity objects, a plurality of labels that includes a first label indicative of a user interface component for the entity object;
rendering, based on the plurality of labels for the task object and at least one of the plurality of entity objects, the graphical user interface that includes a panel comprising the user interface component; and
providing, to a display device, the graphical user interface.

2. The method of claim 1, wherein the plurality of labels further includes a second label indicative of a data type of the entity object, a third label indicative of the attribute being an identifier, and a fourth label indicative of the user interface component being editable, and wherein the plurality of labels is determined based on a plurality of one-to-one mappings.

3. The method of claim 1, wherein the relationship between the source object and the target object is expressed using a code snippet or a natural language expression.

4. The method of claim 1, further comprising:
receiving, from the user, a modification to the user task;
identifying, based on the plurality of dependencies, one or more entity objects or attributes that are affected by the modification to the user task; and
re-rendering the graphical user interface to update panels associated with each of the one or more entity objects or attributes.

5. The method of claim 4, wherein another natural language prompt or a manipulation of the graphical user interface is indicative of the modification to the user task.

6. The method of claim 1, wherein a type of the user interface component and the first label is determined based on a size of a screen of the display device.

7. The method of claim 1, wherein the panel can be closed, resized, or repositioned on the graphical user interface.

8. A system for generating a graphical user interface for a user task, comprising:
one or more processors configured to:
receive, from a user, a natural language prompt describing the user task,
generate, based on the natural language prompt, a task-driven data model comprising (a) a task object that includes a plurality of entity objects and (b) a plurality of dependencies between objects,
wherein the task object is representative of the user task and each of the plurality of entity objects is representative of a goal or a sub-task of the user task, and
wherein an entity object is associated with an attribute that identifies the entity object as comprising a data structure,
wherein a dependency comprises a source object, a target object, a mechanism that either validates a constraint between the source object and the target object or updates the target object based on a change in the source object, and a relationship between the source object and the target object;
determine, for the task object and at least one of the plurality of entity objects, a plurality of labels that includes a first label indicative of a user interface component for the entity object,
render, based on the plurality of labels for the task object, a home panel, and
render, based on the plurality of labels for at least one of the plurality of entity objects, at least one entity panel comprising the user interface component; and
a display device configured to visually present, to the user, the graphical user interface comprising the home panel and the at least one entity panel.

9. The system of claim 8, wherein the data structure comprises a singular data value, an array of singular data values, a pointer to the entity object, an array of pointers, or a key-value dictionary pair.

10. The system of claim 8, wherein the one or more processors is further configured to:
receive, from the user, an input indicative of a modification to the user task;
parsing the input to identify one or more entity objects or attributes that are affected by the modification to the user task and an action comprising a task-level operation or a data-specific operation; and
re-rendering, based on the action and the one or more entity objects or attributes, one or more entity panels corresponding to the one or more entity objects or attributes.

11. The system of claim 10, wherein the task-level operation comprises adding a new entity object, removing an existing entity object, or updating the existing entity object, and wherein the data-specific operation comprises updating data in the existing entity object.

12. The system of claim 8, wherein the data structure associated with the at least one entity panel can be represented in the graphical user interface using a map view, a list view configured to display one or more details of data in the data structure, or a table view configured to display a summary of the data in the data structure.

13. The system of claim 8, wherein the plurality of labels further includes a second label indicative of a data type of the entity object, a third label indicative of the attribute being an identifier, and a fourth label indicative of the user interface component being editable, and wherein the plurality of labels is determined based on a plurality of one-to-one mappings.

14. The system of claim 8, wherein the relationship between the source object and the target object is expressed using a code snippet or a natural language expression.

15. A system for generating a graphical user interface for a user task, comprising:
one or more processors configured to:
receive, from a user, a natural language prompt describing the user task,
generate, based on an output of a large language model (LLM) configured to process the natural language prompt, a task-driven data model comprising (a) a task object that includes a plurality of entity objects and (b) a plurality of dependencies between objects,
wherein the task object is representative of the user task and each of the plurality of entity objects is representative of a goal or a sub-task of the user task, and
wherein an entity object is associated with an attribute that identifies the entity object as comprising a data structure,
wherein a dependency comprises a source object, a target object, a mechanism that either validates a constraint between the source object and the target object or updates the target object based on a change in the source object, and a relationship between the source object and the target object;
determine, for each attribute of at least one of the plurality of entity objects, a plurality of labels that includes a first label indicative of a user interface component for the entity object;
render, based on the plurality of labels for the task object and at least one of the plurality of entity objects, the graphical user interface that includes a panel comprising the user interface component; and
provide, to a display device, the graphical user interface.

16. The system of claim 15, wherein the relationship between the source object and the target object is expressed using a code snippet or a natural language expression.

17. The system of claim 15, wherein a type of the user interface component and the first label is determined based on a size of a screen of the display device.

18. The system of claim 15, wherein the plurality of labels further includes a second label indicative of a data type of the entity object, a third label indicative of the attribute being an identifier, and a fourth label indicative of the user interface component being editable, and wherein the plurality of labels is determined based on a plurality of one-to-one mappings.

19. The system of claim 15, wherein the one or more processors is configured to:
receive, from the user, an input indicative of a modification to the user task;
parse the input to identify one or more entity objects or attributes that are affected by the modification to the user task and an action comprising a task-level operation or a data-specific operation; and
re-render, based on the action and the one or more entity objects or attributes, one or more entity panels corresponding to the one or more entity objects or attributes.

20. The system of claim 19, wherein the task-level operation comprises adding a new entity object, removing an existing entity object, or updating the existing entity object, and wherein the data-specific operation comprises updating data in the existing entity object.
